(19) United States
(12) Patent Application Publication
(10) Pub. No.: US 2024/0174105 A1
(43) Pub. Date: May 30, 2024

(54) LUMINAIRE INTEGRATED INTO AN ELECTRICAL VEHICLE CHARGER

(71) Applicant: LEDVANCE LLC, Wilmington, MA (US)

(72) Inventors: Ming Li, Acton, MA (US); Sally Lee, Dallas, TX (US); Tianzheng Jiang, Shenzhen (CN); Bruce Li, Shenzhen (CN)

(21) Appl. No.: 18/384,238

(22) Filed: Oct. 26, 2023

Related U.S. Application Data
(60) Provisional application No. 63/419,476, filed on Oct. 26, 2022.
(60) Provisional application No. 63/458,762, filed on Apr. 12, 2023.

(51) Int. Cl. B60L 53/31; B60L 53/16; B60L 53/30; F21S 8/08; H02J 7/00

(52) U.S. Cl. CPC B60L 53/31; B60L 53/16; B60L 53/305; F21S 8/083; H02J 7/0042

(57) ABSTRACT

An electric vehicle supply equipment that includes a form factor fitting a charging station including one interface for charging electric vehicles and at a second interface for powering street lighting. The first interface including a voltage for supporting level 2 charging. The electric vehicle supply equipment can also include an electrical box mounted to the structure with a form factor fitting the charging station that includes a connection to grid power. The electrical box includes an AC circuit, wherein a splitter provides for electrical communication from the AC circuit to the first and second interface, wherein the splitter provides for splitting the neutral and line cables of the AC input into a first branch that provides electrical communication to the first interface having the voltage for supporting level 2 charging, and a second branch that provides electrical communication to the second interface for powering the luminaire.

### CROSS REFERENCE TO RELATED APPLICATIONS

This application claims the benefit of U.S. Provisional Application No. 63/419,476 filed Oct. 26, 2022 titled “LUMINAIRE INTEGRATED INTO AN ELECTRICAL VEHICLE CHARGER”, which is incorporated herein in its entirety by reference.

This application claims the benefit of U.S. Provisional Application No. 63/458,762 filed Apr. 12, 2023 titled “LUMINAIRE INTEGRATED INTO AN ELECTRICAL VEHICLE CHARGER”, which is incorporated herein in its entirety by reference.

### TECHNICAL FIELD

The present disclosure generally relates to electric vehicle chargers, and more particularly to electrical vehicle chargers that are integrated with luminaires for lighting.

### BACKGROUND

In recent years, the popularity and affordability of electric vehicles (EVs) such as battery-powered EVs (BEVs) and hybrid gasoline-electric EVs (HEVs) has grown dramatically. In many cases, the batteries of these vehicles require periodic recharging to keep them in motion. Industry leaders have recognized this need and have identified and implemented a number of charging protocol standards, such as, for example, the Society of Automotive Engineers (SAE) J1772 AC “Level 2” charging standard or the TEPCO® CHAdeMO® DC “quick charge” or “Level 3” charging standard, including corresponding charger connectors and ports.

Level 2 means a voltage of 240 volts, which a house generally already has for appliances like a clothes dryer, electric oven or central air conditioner whether you use these items or not. Unfortunately, voltage is just one factor behind the power that charges a battery; current is the second factor, and the amount of current supported by Level 2 extends from 12 to 80 amps. For example, the Level 2 charger can have a rating of 12, 16, 20, 24, 32, 40, 48 or 64 amps—and some can be set to throttle down to lower current levels to accommodate being fed by less robust circuits. Charging at this level called Level 2 for one hour could translate to adding 5.5 miles of range or 60 miles of range.

### SUMMARY

In one aspect, an electric vehicle (EV) charger device is provided for electric vehicles (EV). The electrical vehicle (EV) charger is integrated with an overhead luminaire. The electrical vehicle (EV) charger provides a voltage suitable for Level 2 charging for an electrical vehicle charger, and through the use of a splitter the charger can simultaneously provide a power source for powering the luminaire.

In one embodiment, the electric vehicle supply equipment includes a structure having a form factor fitting a charging station including one interface for charging electric vehicles and at a second interface for powering overhead street lighting, wherein the first interface including a voltage for supporting level 2 charging, and the second interface for powering a luminaire; and an electrical box mounted to the structure that includes a connection to grid power. The electrical box includes an AC circuit, wherein a splitter provides for electrical communication from the AC circuit to the first and second interface. In some embodiments, the splitter provides for splitting the neutral and line cables of the AC input into two branches, wherein a first branch of neutral and line cables provide electrical communication to the first interface having the voltage for supporting level 2 charging, and a second branch of neutral and line cables provide electrical communication to the second interface for powering the luminaire. The electric vehicle supply equipment includes an electric vehicle charger plug assembly in electrical communication with the first interface; and the luminaire mounted to the housing and including electrical communication with the second interface.

In another aspect, an electric vehicle supply equipment is provided for electric vehicles, in which the charger is integrated with an overhead luminaire, in which the charger provides a voltage of 240V, e.g., Level 2 charging, for the electrical vehicle charger, and through the use of a splitter the charger can provide a 100 VAC-277 VAC power source for powering the luminaire.

In one embodiment, the electric vehicle supply equipment includes a structure having a form factor fitting a charging station including one interface for charging electric vehicles and at a second interface for powering overhead street lighting, wherein the first interface includes 240V outlet and the second interface includes a 100 VAC-277 VAC outlet; and an electrical box mounted to the structure that includes a connection to grid power. The electrical box includes a 240V AC circuit, wherein a splitter provides for electrical communication from the 240V AC circuit to the first and second interface. In some embodiments, the splitter provides for splitting the neutral and line cables of the AC input into two branches, wherein a first branch of neutral and line cables provide electrical communication to the first interface that includes the 240V outlet and a second branch of the neutral and line cables provide electrical communication to the second interface that includes the 100 VAC-277 VAC outlet. The electric vehicle supply equipment includes an electric vehicle charger plug assembly in electrical communication with the first interface; and an overhead luminaire mounted to the housing and including electrical communication with the second interface that includes the 100 VAC-277 VAC outlet for powering the luminaire.

In yet another aspect of the present disclosure, an electrical vehicle charger is provided for electric vehicles, in which the charger is integrated with a bollard luminaire.

In one embodiment, a structure having the form factor for the electrical vehicle charger is provided having exterior dimensions consistent with a bollard luminaire. The structure having the form factor for the electrical vehicle charger includes one interface for charging electric vehicles, and at a second interface for powering bollard lighting. The first interface includes a 240V outlet. The second interface includes a 100 VAC-277 VAC outlet. The form factor for the electrical vehicle charger includes an electrical box that includes a connection to grid power, which includes a 240V AC circuit. In some embodiments, a splitter provides for electrical communication from the 240V AC circuit to the first and second interface, the splitter includes splitting the neutral and line cables of the AC input into two branches, wherein a first branch of neutral and line cables provide electrical communication to the first interface that includes the 240V outlet and a second branch of the neutral and line cables provide electrical communication to the second interface that includes the 100 VAC-277 VAC outlet. The electric vehicle supply equipment includes an electric vehicle charger plug assembly in electrical communication with the first interface that includes the 240V outlet. The bollard luminaire is connected to the second interface including the 100 VAC-277 VAC outlet. The connection of the bollard luminaire may be on the sidewall of the form factor for the charger.

In an even further aspect, a method of providing lighting for a charging station is provided.

In one embodiment, the method includes providing a structure having a form factor fitting a charging station including a first interface for charging electric vehicles and a second interface for powering a luminaire, wherein the first interface including a voltage for supporting level 2 charging, and the second interface is for powering the luminaire. The method may further include connecting an electrical box for the charging station to grid power that includes an AC circuit, wherein a splitter provides for electrical communication from the AC circuit to the first and second interface. The splitter provides for splitting the neutral and line cables of the AC input into two branches. In some embodiments, a first branch of neutral and line cables provide electrical communication to the first interface having the voltage for supporting level 2 charging, and a second branch of neutral and line cables provide electrical communication to the second interface for powering the luminaire. The method further includes installing a plug for engaging the charging point of an electric vehicle to the first interface, and mounting the luminaire to the structure having the form factor fitting the charging station having electrical communication with the second interface.

In one aspect, an electric vehicle (EV) charger device is provided for electric vehicles (EV). The electrical vehicle (EV) charger is integrated with an overhead luminaire. The electrical vehicle (EV) charger includes a step down converter that provides a voltage suitable for Level 2 charging for an electrical vehicle charger, and can simultaneously provide a power source for powering the luminaire.

In one embodiment, a structure having a form factor for the charger is provided having exterior dimensions consistent with overhead street lighting. The structure having the form factor for the electrical vehicle charger may include one interface for charging electric vehicles, and at a second interface for powering overhead street lighting. The first interface includes 240V outlet. The structure having the form factor for the electrical vehicle charger may include a 120V outlet. The structure having the form factor for the electrical vehicle charger may include includes electrical box that includes a connection to grid power, which includes a 240V AC circuit. The electrical box includes a 240V contactor that is in electrical communication with the 240V AC circuit for the connection to the power grid. In some embodiments, the 240V contactor is in electric communication with the first interface. In some embodiments, a step down converter is provided that converts the 240V output from the 240V contactor to a 120V output for the 120V outlet.

In another aspect of the present disclosure, a charger is provided for electric vehicles, in which the charger is integrated with a bollard luminaire. In one embodiment, a structure having the form factor for the electrical vehicle charger is provided having exterior dimensions consistent with a bollard luminaire. The structure having the form factor for the electrical vehicle charger includes one interface for charging electric vehicles, and at a second interface for powering bollard lighting. The first interface includes a 240V outlet. The second interface includes a 120V outlet. The form factor for the electrical vehicle charger includes an electrical box that includes a connection to grid power, which includes a 240V AC circuit. The electrical box includes a 240V contactor that is in electrical communication with the 240V AC circuit for the connection to the power grid. In some embodiments, the 240V contactor is provided that is in electric communication with the first interface. In some embodiments, a step down converter is provided that converts the 240V output from the 240V contactor to a 120V output for the 120V outlet. The bollard luminaire is connected to the 120V outlet. The connection of the bollard luminaire may be on the sidewall of the form factor for the charger.

In yet another embodiment, a method of providing lighting for a charging station is provided. In one embodiment, the method includes providing a structure having a form factor fitting a charging station having a first interface for electric vehicle charging at 240V and a second interface for powering a luminaire that is mounted to the charging station housing for powering at 120V. The method further includes connecting an electrical box for the charging station to grid power that includes a 240V AC circuit. The electrical box includes a 240V contactor that is in electrical communication with the first interface, and a step down converter for providing the 120V power for powering the luminaire at the second interface. The method may further include installing a plug for engaging the charging point of an electric vehicle to the first interface, and mounting a luminaire to the charging station housing having electrical communication with the second interface.

In yet another embodiment, a method of retrofitting the wiring of a base structure for an electrical vehicle charger to include a luminaire is described. The method may include mounting a base plate to an anchor base structure. The anchor base structure can include a main conduit with power source wiring extending therethrough. The base plate can include an opening for a main conduit passthrough and a secondary conduit integral with the base plate laterally spaced from the main conduit passthrough. Mounting of the base plate to the base structure provides a spaced therebetween having dimensions for the passage of wiring. The method can further include mounting a main body including an electrical box therein to the base plate, wherein the power source wiring extends to the electrical box and splits to include a branch that extends back to the main conduit passthrough in the base plate. The method can further include extending the branch that extended through the main conduit passthrough along a backside of the base plate to the secondary conduit that is integral with the base plate. Additionally, the method can include mounting a cable management structure, in which a passageway extends through the cable management structure to a luminaire. The method can further include connecting the branch from the power source wiring that split at the electrical box and extended back through the main conduit passthrough to the luminaire.

### BRIEF DESCRIPTION OF THE DRAWINGS

The following description will provide details of embodiments with reference to the following figures wherein:

FIG. 1 is a front view of an electric vehicle (EV) chargers including an integrated street light luminaire, in accordance with one embodiment of the present disclosure.

FIG. 2 is a side view of an electric vehicle (EV) charger including the integrated street light luminaire that is depicted in FIG. 1.

FIG. 3 is a perspective view of the electric vehicle (EV) charger including the integrated street light luminaire that is depicted in FIG. 1, wherein the luminaire is disconnected from the housing including the electric vehicle (EV) charger.

FIG. 4A is an isometric view of one embodiment of an electric vehicle (EV) charge station with a cover removed to illustrate a design including a splitter, in accordance with one embodiment of the present disclosure.

FIG. 4B is an isometric view of one embodiment of an electric vehicle (EV) charge station with the cover removed to illustrate a design including a step down converter, in accordance with one embodiment of the present disclosure.

FIG. 5 is an isometric view of one embodiment of an electric vehicle (EV) charge station that is depicted in FIGS. 4A and 4B with the cover installed.

FIG. 6A is a perspective view of splitter that provides for splitting the neutral and line cables of the AC input into two branches, wherein a first branch of neutral and line cables provide electrical communication to the first interface having the voltage for supporting level 2 charging, and a second branch of neutral and line cables provide electrical communication to the second interface for powering a luminaire, in accordance with one embodiment of the present disclosure.

FIG. 6B is a perspective view of splitter that is depicted in FIG. 6A with the cover removed.

FIG. 6C is a magnified perspective view of the splitter depicted in FIG. 6B with the cover removed.

FIG. 6D is a perspective view of the split connector as used in the splitter that is depicted in FIGS. 6A-6C illustrating the input for the main neutral and line cable.

FIG. 6E is a perspective view of the split connector as used in the splitter that is depicted in FIGS. 6A-6C illustrating the output for the split lines for the two branches of neutral and line cables.

FIG. 6F is a perspective view illustrating the electrically conductive splitter body of the split connector depicted in FIGS. 6A-6E.

FIG. 6G is a perspective view of an EV charger including a splitter with a removed section to illustrate the inner working of the charger, in accordance with one embodiment of the present disclosure.

FIG. 6H is a block diagram illustrating one example of a wiring schematic for employing the splitter depicted in FIGS. 4A and 6A-6E, in accordance with one embodiment of the present disclosure.

FIG. 7 is a circuit diagram illustrating an exemplary electrical circuit of the charge station depicted in FIG. 4B, in accordance with one embodiment of the present disclosure.

FIG. 8 is a perspective view of a socket component of a socket plug assembly that is present at the second interface for providing reversible engagement to a plug component of the socket plug assembly that is present in the luminaire support arm, in accordance with one embodiment of the present disclosure.

FIG. 9 is a perspective view of a socket component of a socket plug assembly as depicted in FIG. 8 further including a cover for the socket component when a luminaire is not in use, in accordance with one embodiment of the present disclosure

FIG. 10 is an exploded view of the socket component depicted in FIG. 9, in accordance with one embodiment of the present disclosure.

FIG. 11 is an exploded view of a plug component of the socket plug assembly that is present in the end of the luminaire support arm for engagement to the socket component that is present at the second interface, in accordance with one embodiment of the present disclosure.

FIG. 12 is a sectioned view of plug component of the socket plug assembly mounted into the end of the luminaire support arm, in accordance with one embodiment of the present disclosure.

FIG. 13 is a sectioned view illustrating electrical conduit within the tube structure of the luminaire arm for providing electrical communication from the luminaire to the plug component, in accordance with one embodiment of the present disclosure.

FIG. 14 is a cross-sectional view illustrate one embodiment of the engagement of the plug component of the socket plug assembly to the socket component of the socket plug assembly illustrating engagement of the luminaire support arm to the second interface at the support pillar, in accordance with one embodiment of the present disclosure.

FIG. 15 is a front view of an electric vehicle (EV) chargers including an integrated bollard luminaire, in accordance with one embodiment of the present disclosure.

FIG. 16 is a perspective view of the electric vehicle (EV) charger including the integrated bollard luminaire that is depicted in FIG. 1, wherein the luminaire is disconnected from the housing including the electric vehicle (EV) charger.

FIG. 17 is perspective view of a socket component for a third interface with the electrical vehicle charger for powering the bollard illumination, in accordance with one embodiment of the present disclosure.

FIG. 18 is perspective view of a socket component for the third interface in which a sealing cap is mounted on the socket opening.

FIG. 19 is an exploded view of the socket component that is depicted in FIG. 17.

FIG. 20 is a side cross-sectional view of a bollard support arm having a plug component integrated therein for engagement to the socket component that is depicted in FIG. 16, in accordance with one embodiment of the present disclosure.

FIG. 21 is a sectional view illustrating engagement of the plug component to the socket component of the plug and socket assembly at the third interface of the electric vehicle supply equipment.

FIG. 22 is a perspective view illustrating mounting a pole and base plate assembly for the mounting structure to a concrete base including fasteners, in accordance with one embodiment of the present disclosure.

FIG. 23 is a perspective view illustrating mounting a main body to the pole and base plate assembly, in which the main body includes an electrical box for mounting an electric vehicle charger.

FIG. 24 is a perspective view illustrating wiring the electrical box.

FIG. 25 is a perspective view of a cable management structure/retractor assembled to the main body.

FIG. 26 is a perspective view of an electric vehicle supply equipment (EVSE), e.g., electrical vehicle charger, assembled using the structures that were assembled in accordance with FIGS. 22-25.

FIG. 27 is a perspective view of a concrete base including fasteners and a main conduit to the electrical box for the electrical vehicle charger, in accordance with one embodiment of the present disclosure.

FIG. 28 is a perspective view of a base adapter composed of welded rigid metal including mounting points for the pole and base plate assembly, an opening for main conduit, and an integral conduit for wiring to a luminaire, in accordance with one embodiment of the present disclosure.

FIG. 29 is a sectioned view of the base adapter mounted to the concrete base that is depicted in FIG. 28.

FIG. 30 is a perspective view of an upper surface of a base adapter composed of welded rigid metal, in accordance with one embodiment of the present disclosure.

FIG. 31 is a perspective view of a backside surface of a base adapter composed of welded rigid metal, in accordance with one embodiment of the present disclosure.

FIG. 32 is a perspective view of the base adapter as depicted in FIGS. 30 and 31 mounted to the concrete base, and a pole and base plate assembly mounted to the base adapter, in accordance with one embodiment of the present disclosure.

FIG. 33 is a sectioned view of the base adapter mounted to the concrete base, and a pole and base plate assembly mounted to the base adapter that is depicted in FIG. 32.

FIG. 34 is a perspective view of a splitter 300a integrated into a main body, in accordance with one embodiment of the present disclosure.

FIG. 35 is a perspective view of an upper surface of a base adapter composed of cast metal, in accordance with one embodiment of the present disclosure.

FIG. 36 is a perspective view of a backside surface of a base adapter composed of cast metal, in accordance with one embodiment of the present disclosure.

FIG. 37 is a perspective view of the base adapter as depicted in FIGS. 35 and 36 mounted to the concrete base, and a pole and base plate assembly mounted to the base adapter, in accordance with one embodiment of the present disclosure.

### DETAILED DESCRIPTION

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

The structures and methods of the present disclosure can provide electric vehicle (EV) chargers, e.g., electric vehicle supply equipment (EVSE), which are integrated with outdoor luminaires, such as street lights and outdoor bollards luminaires.

Electric vehicle supply equipment (EVSE) stands for electric vehicle supply equipment. Its function is to supply electric energy to recharge electric vehicles. EVSEs are also known as EV charging stations, electric recharging points or just charging points. EVSEs can provide a charge for the operation of electric vehicles or plug-in hybrid electric-gasoline vehicles. As used herein, electronic vehicle (EV) are vehicles that are either partially or fully powered on electric power. This includes not only battery electric vehicles (BEV), but also Plug in Hybrid Electric Vehicles (HEV). Battery operated electronic vehicles (EV) rely solely upon an electric motor for motive force. For plug-in Hybrid Electric Vehicles (PHEV), rather than relying solely on an electric motor, hybrid electric vehicles offer a mixture of battery and petrol (or diesel) power.

The electric vehicle supply equipment (EVSE) may be characterized as level 1, 2 and 3. A level 1 charger operates with a 120V outlet, and can deliver around 1.2 kW to the electric vehicle being charged. A Level 2 charge station can be found in public locations and at homes. This type of station charges at a rate of 10 to 20 electric miles per hour. A Level 2 charging station is hardwired or plugged-into a 240-volt outlet. Level 2 charging stations may use either single phase or three phase AC power from the grid. Level 3 charging can be referred to as DC fast charging or super charging employs 400-Volt to 900-Volt, and can achieve charging speeds ranging from 3 to 20 miles per minute. The chargers of the present disclosure generally are level 2 chargers.

It has been determined that a charging location for electronic vehicles (EV) may include EV charger piles, e.g., level 2 chargers mounted to supporting structures, and illumination structures, such as bollard illumination and street lights, occupying multiple and separate areas.

A “charger pile” may include a base, such as a cement base, for supporting a charger stand pillar, in which the EV charger (EVSE) is mounted to the charger stand pillar. AC power is generally conducted by a cable which has more than five wires, such as live (L), neutral (N), ground (GND), Signal (+) and Signal (−). The power line is generally run within a plastic protective pipe (conduit) buried in the cement floor and the cement base, and then up through the charger stand pillar to the EV charger (EVSE).

In some embodiments of the methods and structures of the present disclosure, the AC power is routed to a plug for the EV charger (EVSE) and to the luminaire, e.g., overhead luminaire and/or bollard luminaire, using a splitter. The splitter can be provided by converting a single wiring scheme into two separate physical branches. For example, as described herein, when the input voltage to the electric vehicle supply equipment (EVSE) is 240 VAC, the splitter branches the neutral and line cables of the AC input into two separate branches, e.g., a first branch of neutral and line cables in electrical communication with the AC input, and a second branch of neutral and line cables also in communication with the same AC input. For example, one of the branches, i.e., a first branch, of a neutral and line cable from the AC input, is sent to power the EV charger, e.g., sent to interface with the plug of the EV charger; and a second of the branches, i.e., a second branch of a neutral and line cables from the AC input, is sent to power the luminaire, e.g., sent to the overhead luminaire or bollard luminaire. As will be described herein, a number of different power configurations may be used to power both the EV charger and the luminaire. For example, the luminaire may accept 100 VAC-277 VAC, while the EV charger may accept 240 VAC. However, other embodiments can provide for single-phase 120 VAC, 240 VAC, 277 VAC, 480 VAC, and 3-phase 120 VAC, 208 VAC, 240 VAC, 277 VAC, 480 VAC. In each of the above configurations, any of the 2 input wires, regardless of voltage (or phase) can be split into 2 to be fed into the EV chargers and the luminaire, e.g., overhead luminaire and/or bollard luminaire.

In other embodiments to provide 120V to power the luminaire, the charging station includes a step down converter, e.g., step down transformer. For example, inside the charging station, the 240V wire are connected in parallel to the primary winding of a 240V to 120V step down transformer, and to the two terminals of a normally open AC contactor.

“Bollard lights” (also referred to as “Bollard illumination”) are lights on a bollard. “Bollards” are posts meant to form a boundary, like those blocking off a street from cars. The lights are an addition so that the bollards can: Illuminate walkways and landscaping. Bollard lighting is a way of illuminating walkways, building perimeters and accenting site features without upward or overhead lighting. “Street lights”, which can also be referred to as a “light pole”, “lamp pole”, “lamppost”, street lamp, light standard, or lamp standard is a raised source of light. Street lights can be positioned to be on the edge of a road or path. For example, in comparison to a typical human scale, a street light is a form of illumination that is positioned overhead, whereas a bollard light is more proximate to the ground, e.g., waist height or less.

Prior to the structures and methods of the present disclosure, each of the aforementioned structures, e.g., EV charger, street light and bollard illumination, are separate, and therefore installed separately. In this example, one has to install the independent chargers and illumination structures separately, which results in a high installation cost.

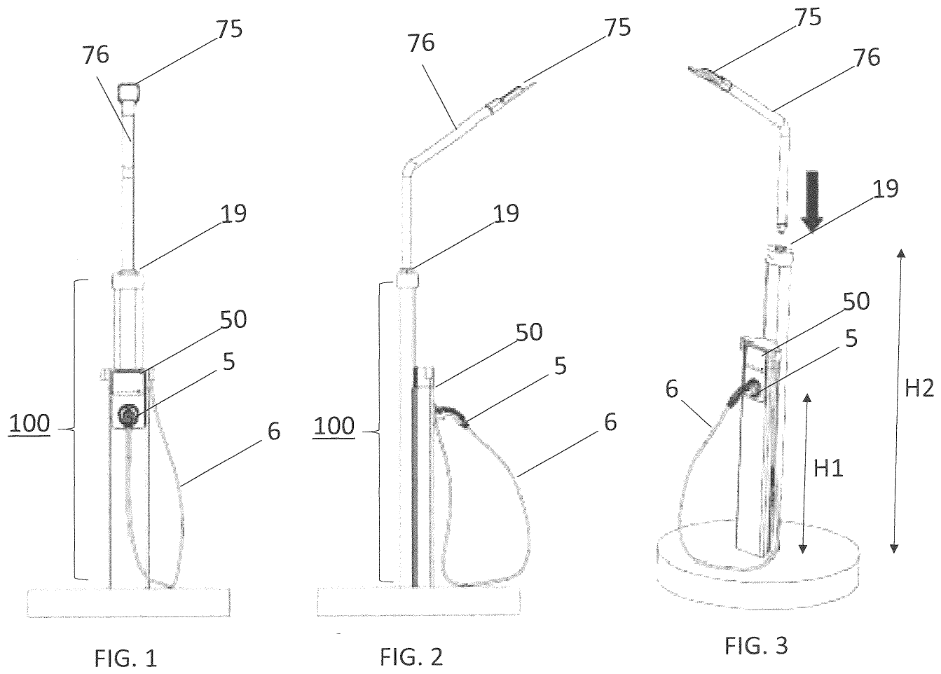

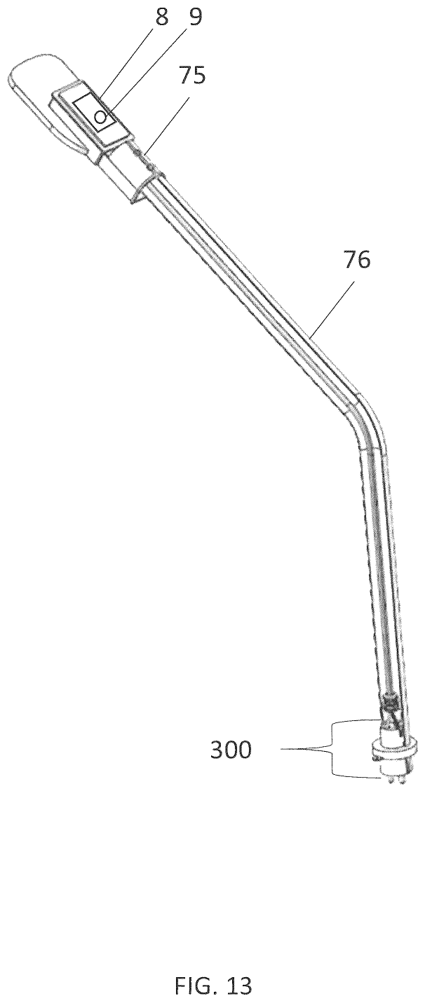

The structures and methods of the present disclosure can provide electric vehicle (EV) chargers, e.g., electric vehicle supply equipment (EVSE), which are integrated with outdoor luminaires, such as street lights and outdoor bollards luminaires. The combined EV charger and luminaires described herein can reduce installation costs when compared to individual and separate EV chargers and luminaires in the same space. The combined EV charger and luminaires occupy less of a footprint when compared to separate EV chargers and luminaires. The combined EV charger and luminaire provide options for detachable luminaires. With this option users can opt to install luminaires on EV chargers or remove luminaires from EV chargers. The methods and structures of the present disclosure are now described with reference to FIGS. 1-20.

FIGS. 1-3 illustrate one embodiment of an electric vehicle (EV) chargers 100 including an integrated street light luminaire 75. In one embodiment, the electrical vehicle charger 100 assembly includes a structure having a structure having a form factor of a vehicle charger, and having exterior dimensions consistent with overhead street lighting. The term “form factor” when used in combination with a vehicle charger means the geometry of the exterior surfaces of the portions of the structure that provide the charging points for the vehicle, as well as the supporting structure and its geometry. The form factor for the electric charger can include one first interface 18 for charging electric vehicles, and at a second interface 19 for powering overhead street lighting 75. The first interface 18 has a voltage output for supporting level 2 charging of an electrified vehicle. For example, the first interface 18 may be configured to provide a 240V outlet. The second interface 19 includes an outlet for supporting a luminaire including a light source that is provided by a solid state light source, such as a light emitting diode. The second interface 19 may include a 120V outlet. The term “outlet” denotes a connection. It is not intended to limit the disclosure to a specific outlet format, such as NEMA defined outlets.

Referring to FIGS. 1-8, in some embodiments, the electrical vehicle (EV) charger includes an electrical box, e.g., charge station 50, mounted to the structure with the form factor of a vehicle charger that includes a connection to grid power. In one embodiment, the electrical box, e.g., charge station 50, includes connection to an AC circuit as the connection to the grid power. In some examples, the AC circuit is a 240V AC circuit.

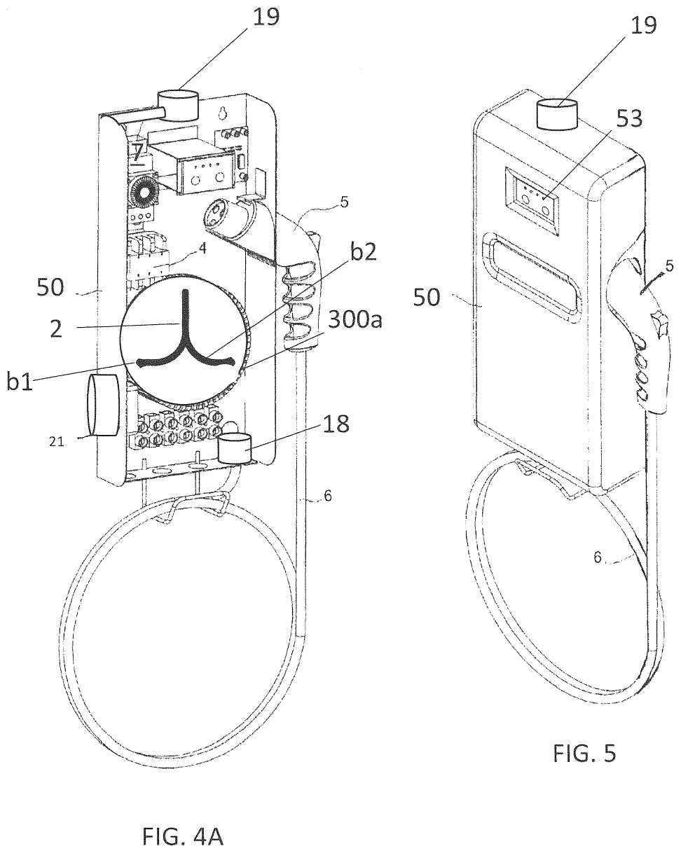

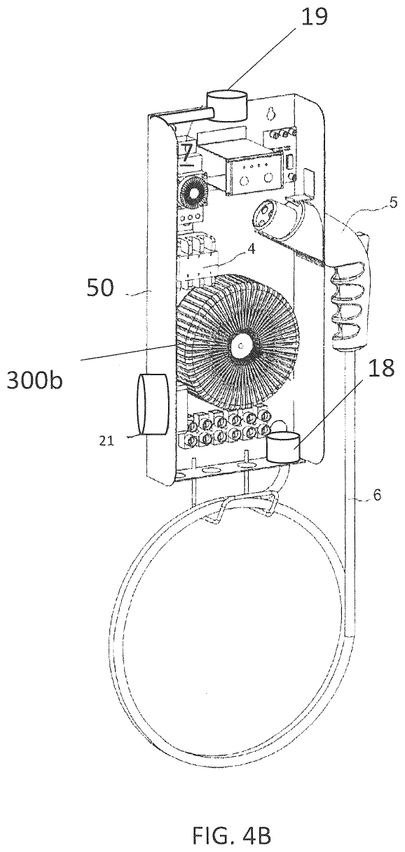

In some embodiments, the charge station 50 includes a splitter 300a, in which the splitter 300a splits the neutral and line cables of the AC input to provide two branches, as depicted in FIG. 4A. The first branch provides power, e.g., 240V, to be used by an electrical charger for charging an electric vehicle. The second branch provides power, e.g., 120V, to be used to power a luminaire.

In some embodiments, the charge station 50 includes a step down converter 300b that converts the 240V output from the 240V contactor 4 to a 120V output that provides the second interface 19, e.g., for powering a luminaire, as depicted in FIG. 4B.

In some embodiments, the electrical box, e.g., charge station 50, further includes an 240 v contactor 4 that is in electrical communication with the 240V AC circuit for the connection to the power grid. A “contactor” as described in a 240V contactor 4 is an electrically-controlled switch used for switching an electrical power circuit. In one example, a contactor 4 is controlled by a circuit that has a much lower power level than the switched circuit, such as a 24 volt coil electromagnet controlling a 240 volt motor switch.

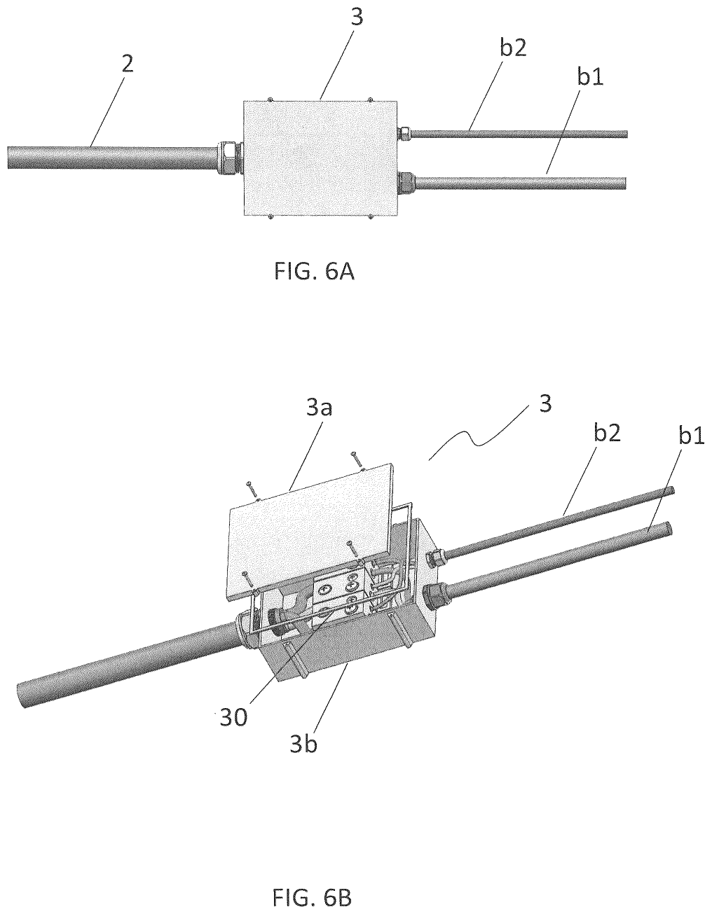

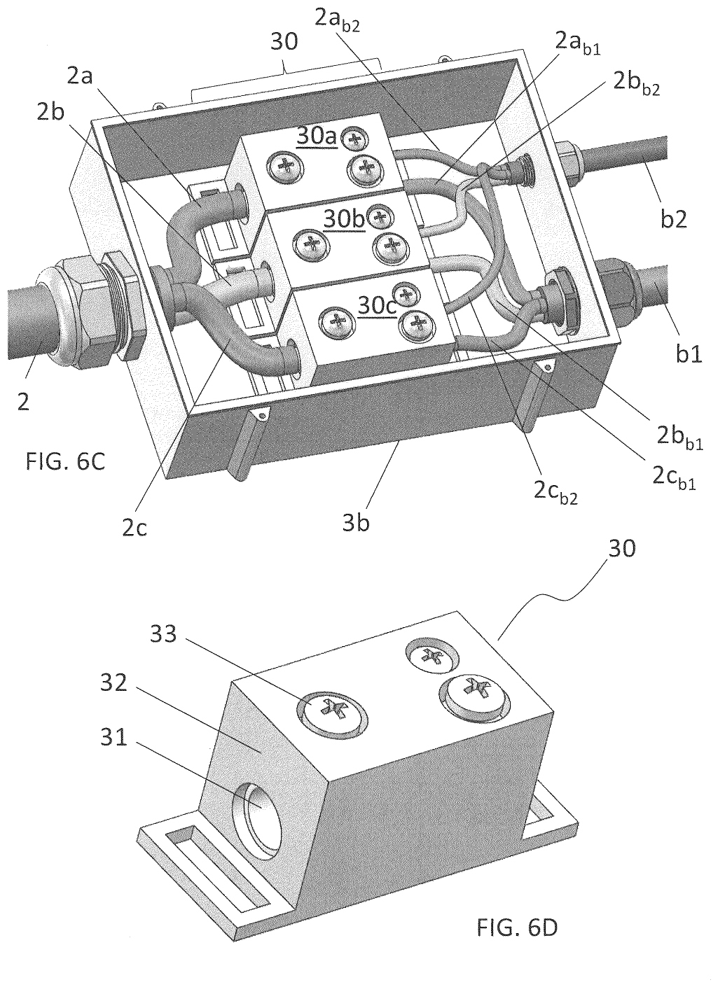

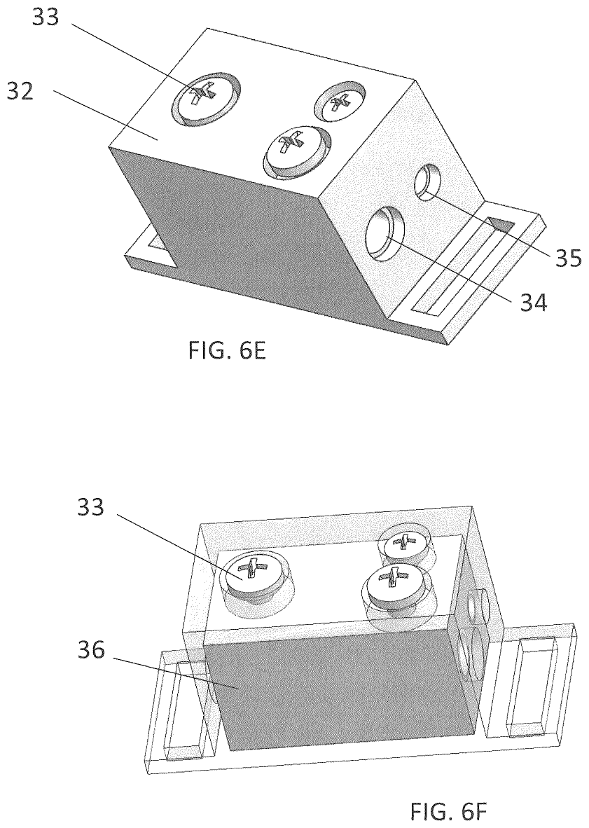

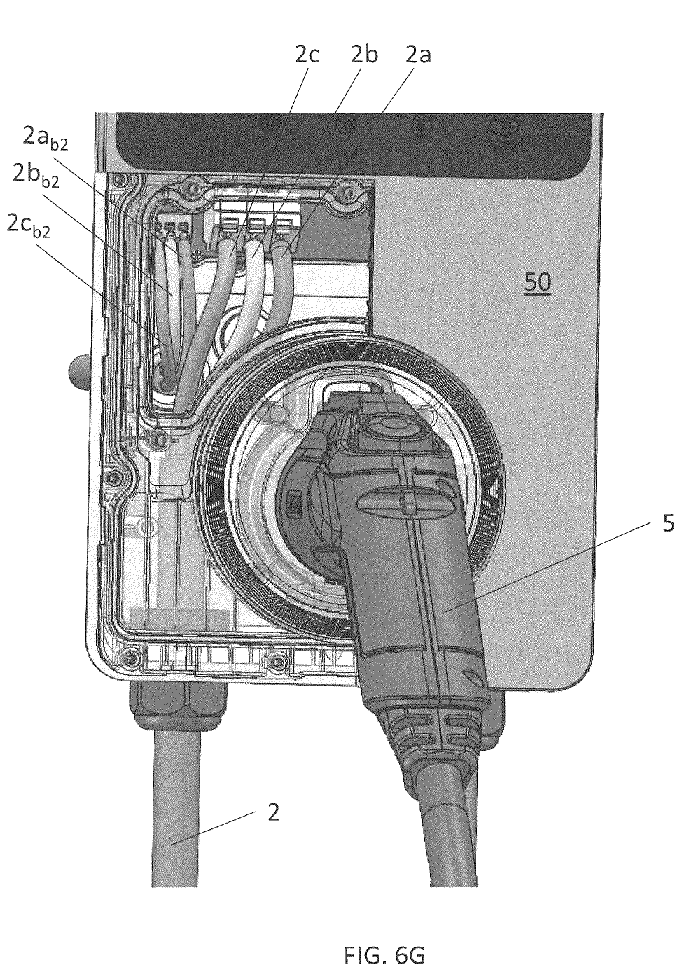

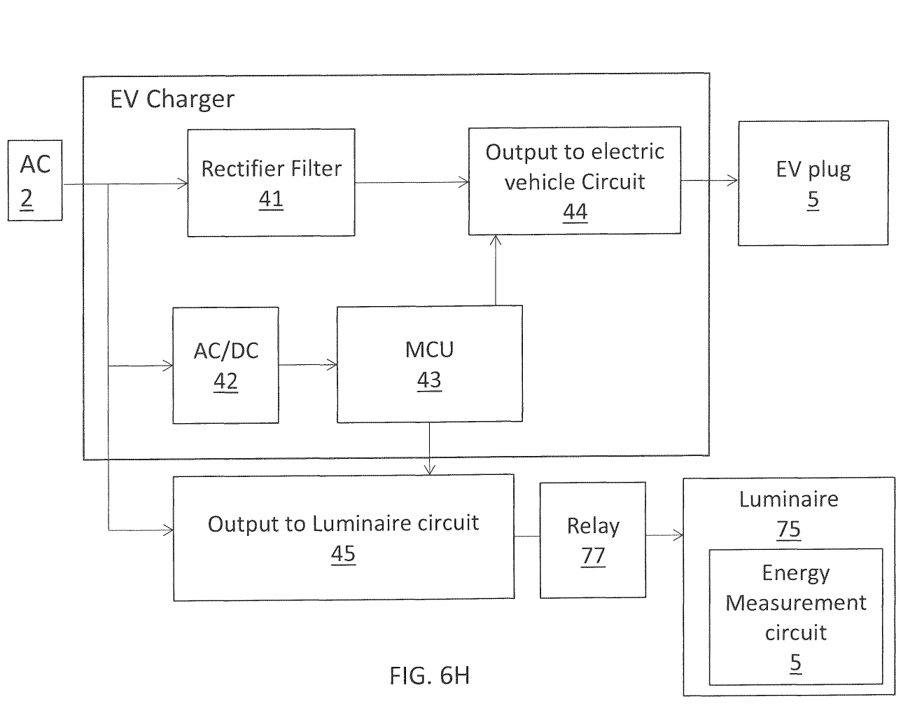

Referring to the embodiments consistent with FIG. 4A, between the contactor and the first and second interfaces is a splitter 300a. In some embodiments, the splitter 300a provides for splitting the neutral and line cables of the AC input 2 into two branches b1, b2, wherein a first branch b1 of neutral and line cables provide electrical communication to the first interface 18 having the voltage for supporting level 2 charging, and a second branch b2 of neutral and line cables provide electrical communication to the second interface 19 for powering the luminaire, e.g., overhead lighting 75. Some embodiments of the splitter 300a are depicted in FIGS. 6A-6G.

FIG. 6A is a perspective view of splitter 300a that provides for splitting the neutral and line cables of the AC input 2 into two branches b1, b2, wherein a first branch b1 of neutral and line cables provide electrical communication to the first interface having the voltage for supporting level 2 charging, and a second branch b2 of neutral and line cables provide electrical communication to the second interface for powering a luminaire. The splitter 300a may include an AC input 2 (e.g., main neutral and line cables), which is the cable bringing power to the splitter 300a from the grid, i.e., grid power. The splitter 300a may include a housing 3. The housing 3 includes a housing box 3b for containing the split connector 30, and a housing cover 3a, as illustrated in FIGS. 6A and 6B. FIG. 6B is a perspective view of splitter 300a that is depicted in FIG. 6A with the cover removed.

FIG. 6C is a magnified perspective view of the splitter 300a depicted in FIG. 6B with the cover removed illustrating connectivity of the cables for the AC input 2 into the two branches b1, b2 that provide for electrical connectivity of the luminaire, e.g., overhead lighting 75, and the charger, e.g., EV plug 5. FIG. 6C illustrates that when the cable for the AC input 3 enters into the housing box 3b, the cable splits into its three components, e.g., a live wire cable 2a, a ground wire cable 2b, and a neutral wire cable 2c. In the embodiment that is depicted in FIG. 6C, each cable, e.g., the live wire cable 2a, the ground wire cable 2b, and the neutral wire cable 2c, that enter the housing box 3b each enter a splitter connector 30. The split connector 30 is depicted in FIGS. 6D-6F.

FIG. 6F illustrates the electrically conductive splitter body 36 of the split connector depicted in FIGS. 6A-6E. The electrically conductive splitter body 36 includes a single input 31 that is in electrical communication with two outputs 34, 35. In some embodiments, the electrically conductive splitter body 36 is composed of a block of electrically conductive material, such as a metal, e.g., copper (Cu), aluminum (Al) or an alloy containing the aforementioned elements. The input 31 and outputs 34, 35 may be openings that are machined into the block of electrically conductive material. The input 31 and outputs 34, 35 may also include a retaining fastener 33. For example, the retaining fastener 33 may be a threaded bolt. The retaining fasteners 33 may be threaded to extend into the openings for the openings for the input 31 and outputs 34, 35. The retaining fasteners 33 may be torqued to extend into the openings in which a cable is present, wherein the retaining fastener 33 can secure the electrically conductive element of the cable to the electrically conductive material of the electrically conductive splitter body 36, hence securing an electrical connection. The electrically conductive material of the electrically conductive splitter body 36 provides for electrical transmission from the cable that is positioned within the single input and the cables that are positioned within the outputs 34, 35. The electrically conductive splitter body 36 is partially enclosed within an insulating cover 32. The insulating cover 32 has openings present therethrough to provide access to the openings for the inputs 31 and outputs 34, 35. The insulating cover 32 is depicted as being transparent in FIG. 6F to allow for the electrically conductive splitter body 36 to be viewed.

FIG. 6D illustrates one embodiment of a split connector 30 as used in the splitter 300a that is depicted in FIGS. 6A-6C illustrating the input 31 for one of the main neutral and line cables, e.g., the live wire cable 2a, a ground wire cable 2b, and a neutral wire cable 2c. For example, as depicted in FIG. 6C, three split connectors 30 may be employed in the housing box 3b of the splitter 300a, in which one split connector 30a, 30b, 30c is used for splitting each of the live wire cable 2a, the ground wire cable 2b, and the neutral wire cable 2c.

FIG. 6E is a perspective view of the split connector 30 as used in the splitter 300a that is depicted in FIGS. 6A-6C illustrating the output 34, 34 for the split lines for the two branches b1, b2 of neutral and line cables, e.g., the live wire cable 2a, a ground wire cable 2b, and a neutral wire cable 2c.

Referring back to FIG. 6C, the cable for the AC input 2 enters into the housing box 3b, the cable splits into its three components, e.g., a live wire cable 2a, a ground wire cable 2b, and a neutral wire cable 2c, in which each of those components are split by the electrically conductive splitter body 36 into two branches b1, b2. Each branch includes a live wire cable 2a_{b1}, 2a_{b2}, a ground wire 2b_{b1}, 2b_{b2}, and a neutral wire 2c_{b1}, 2d_{b2}. For example, the housing box 3b includes a first split connector 30a, which is employed for splitting the live wire cable 2a into two cables, e.g., a first split live wire cable 2a_{b1} for the first branch b1, and a second split live wire cable 2a_{b2} for the second branch b2. The housing box 3b also includes a second split connector 30b, which is employed for splitting the ground wire cable 2b into two cables, e.g., a first split ground wire cable 2b_{b1} for the first branch b1, and a second split ground wire cable 2b_{b2} for the second branch b2. The housing box 3b further includes a third split connector 30c, which is employed for splitting the neutral wire cable 2c into two cables, e.g., a first split neutral wire cable 2c_{b1} for the first branch b1, and a second split ground wire cable 2c_{b2} for the second branch b2. From the outlet of the first, second and third split connectors 30a, 30b, 30c, the first branch b1 that is used to power the EV charger, e.g., EV charger plug 5, includes the first split live wire cable 2a_{b1}, the first split ground wire cable 2b_{b1}, and the first split ground wire cable 2c_{b1}.

In the embodiment that is depicted in FIG. 6C, each cable, e.g., the live wire cable 2a, the ground wire cable 2b, and the neutral wire cable 2c, that enter the housing box 3b each enter a splitter connector 30. The split connector 30 is depicted in FIGS. 6D-6F.

From the outlet of the first, second and third split connectors 30a, 30b, 30c, the first branch b1 that is used to power the EV charger, e.g., EV charger plug 5, includes the first split live wire cable 2a_{b1}, the first split ground wire cable 2b_{b1}, and the first split ground wire cable 2c_{b1}.

From the outlet of the first, second and third split connectors 30a, 30b, 30c, the second branch b2 that is used to power the luminaire, e.g., EV charger plug 5, includes the second split live wire cable 2a_{b2}, the first split ground wire cable 2b_{b2}, and the first split ground wire cable 2c_{b2}.

FIG. 6G is a perspective view of an EV charger including a splitter 300a that is integrated within a charger station 50, as depicted in FIGS. 1-3.

FIG. 6H is a block diagram illustrating one example of a wiring schematic for employing the splitter 300a depicted in FIGS. 6A-6F, in accordance with one embodiment of the present disclosure. The wiring schematic includes the A/C input 2, a rectifier filter 41, an AC/DC rectifier 42, a microcontroller 43, and an output to the luminaire circuit 45. The rectifier filter 41 is positioned between the A/C input 2 and the output to the electric vehicle circuit 44. The output to the electric vehicle circuit 44 may be the first branch b1 that exits the splitter 300a. The rectifier filter 41 helps in converting a pulsating alternating current to direct current, which flows only in one direction. In some embodiments, the electrical performance provided by the rectifier filter 41 is selected to provide the electrical charging characteristics needed for level 2 charging. For example, in some embodiments, the design utilizes a rectifier circuit for converting input AC voltage to high-voltage DC output, and it also has an electromagnetic interference (EMI) filter to eliminate high-frequency noise from the input power source. In some embodiments, A pulse-width modulation (PWM) controller IC, can be used for driving the MOSFETs of a half-bridge converter.

In some embodiments, the microcontroller (MCU) 43 contributes to monitoring the battery voltage and charging current levels and gives feedback to the PWM controller IC. Based on the feedback, the PWM controller varies the duty cycle of its PWM signal and drives the MOSFET circuit to obtain variable output voltage and current for charging the battery. The microcontroller 43 is also powered by direct current. Therefore, an AC/DC rectifier 42 is present between the A/C input 2 and the microcontroller (MCU) 43.

In some embodiments, the A/C input 2 is branched to provide an AC power source to the output of to the luminaire circuit 45. In one example, the branch that provides the AC power source is identified by “b2” in the above descriptions of FIGS. 6A-6G.

It is noted that the embodiments described with reference to FIGS. 1-7, the splitter 300a can be provided by converting a single wiring scheme, e.g., from the grid power 2, into two separate physical branches b1, b2. For example, as described herein, when the input voltage to the electric vehicle supply equipment (EVSE) is 240 VAC, the splitter 300a branches the neutral and line cables of the AC input 2 into two separate branches, e.g., a first branch b1 of neutral and line cables in electrical communication with the AC input 2, and a second branch b2 of neutral and line cables also in communication with the same AC input 2. For example, one of the branches, i.e., a first branch b1, of a neutral and line cable from the AC input, is sent to power the EV charger, e.g., sent to interface (first interface 18) with the plug 5 of the EV charger; and a second of the branches, i.e., a second branch b2 of a neutral and line cables from the AC input 2, is sent to power the luminaire, e.g., sent to the overhead luminaire 75 or bollard luminaire 500. As will be described herein, a number of different power configurations may be used to power both the EV charger and the luminaire. For example, the luminaire, e.g., overhead luminaire 75 or bollard luminaire 500 connected to the second interface 19, may accept 100 VAC-277 VAC, while the EV charger connected to the first interface 18 may accept 240 VAC. However, other embodiments can provide for single-phase 120 VAC, 240 VAC, 277 VAC, 480 VAC, and 3-phase 120 VAC, 208 VAC, 240 VAC, 277 VAC, 480 VAC. In each of the above configurations, any of the 2 input wires, regardless of voltage (or phase) can be split into 2 to be fed into the EV chargers, e.g., EV plug 5, at the first interface 18 and the luminaire, e.g., overhead luminaire 75 and/or bollard luminaire 500, at the second interface 19 and/or third interface 21.

Referring to FIG. 6H, in some embodiments, the luminaire 75 may be in electrical communication with the wiring schematic for employing the splitter 300a depicted in FIGS. 6A-6F via a relay 77. The relay can provide a safety feature as well as a disconnect switch. It is noted that the luminaire 75 may include an energy measurement circuit 78. The energy measurement circuit 78 is also in communication with the control components of the electric vehicle charger. Through the energy measurement circuit 78, the electrical vehicle charger can detect and/or control energy consumption of the luminaire 75. It is noted that the energy measurement circuit 78 is optional, and may be omitted from the designs described herein. In some examples, a similar arrangement without an energy measurement circuit does not allow the electric vehicle charger to control energy consumption of the luminaire 75, however, the electric vehicle charger can still retain functions such as the ability to turn the luminaire “ON” and “OFF”. It is noted that this is only one example, of the present disclosure, and other luminaire controls can still be provided through the electric vehicle charger with or without the energy measurement circuit 78.

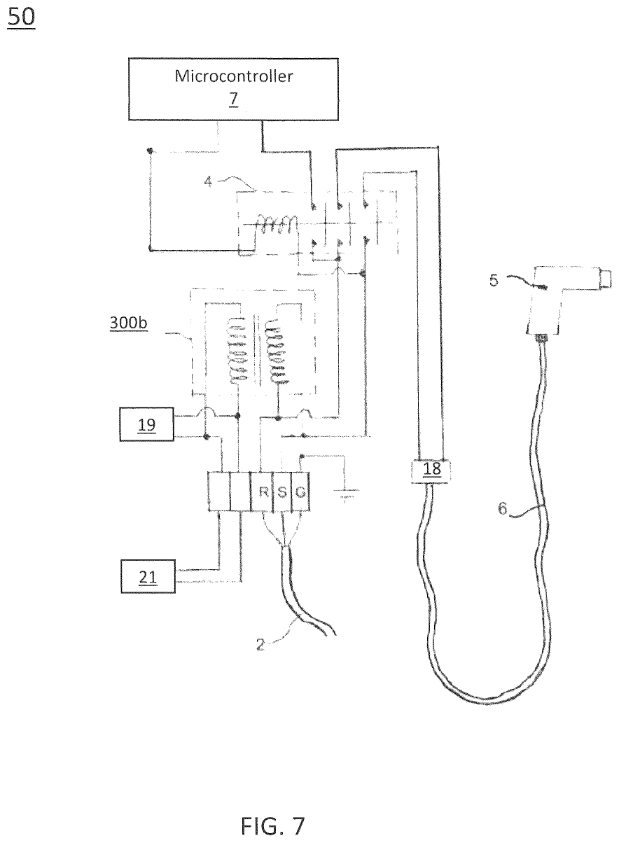

Referring to FIGS. 4B and 7, in some embodiments, the charge station 50, also referred to as electrical box, includes a step-down converter 300b, e.g., step down transformer, instead of the splitter 300a. As noted, the charge station 50 is configured for level 2 charging. The charge station 50 is connected with a 240V AC circuit either by fixed wiring or via a power cord 2 with an appropriate 240V power plug.

To provide that the second interface 19 with a 120 volt outlet, the charging station 50 includes a step down converter 300b, e.g., step down transformer. For example, inside the charging station 50, the 240V wires are connected in parallel to the primary winding of a 240V to 120V step down transformer 300b, and to the two terminals of a normally open AC contactor 4. The output terminals of the contactor 4 are connected to an EV charge plug 5 via a flexible power cable 6.

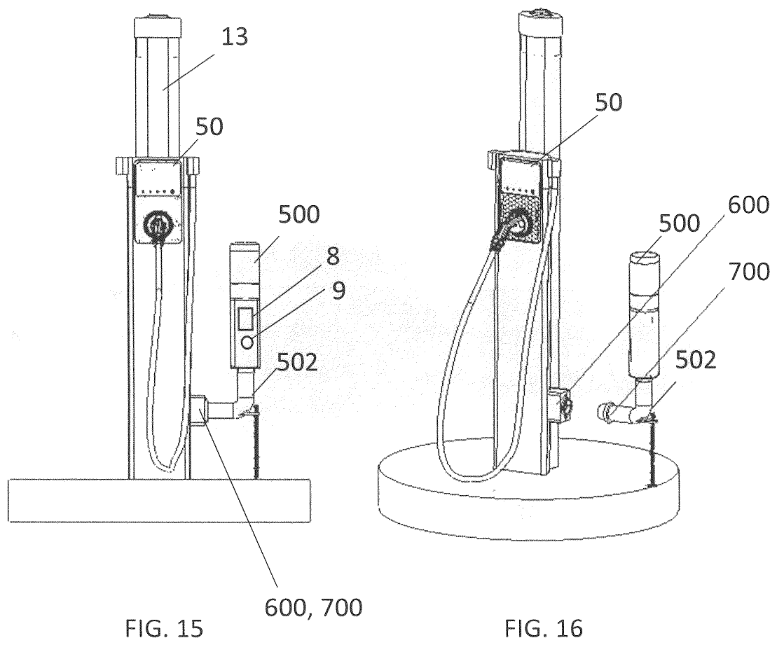

The step down transformer 300b serves to provide 120V power to at least one second interface 19 for powering the overhead luminaire 75 for street lighting mounted to the structure that is housing the charge station 50. For example, the second interface 19 may also be a component of the structure having the form factor of an electrical vehicle charger 100. This provides that both the charge station 50 and the luminaire 75 can be wired from the same connection to the power grid, and that the charge station 50 and the luminaire 75 can be integrated into the same support structure, which reduces the footprint of the space the luminaire and charge station would have occupied if installed separately. In some embodiments, the step down transformer 300b may be in electrical communication with a third interface 21 including an additional 120V outlet, which in some instances can be in electrical communication with bollard illumination as described below with reference to FIGS. 15-21.

In some embodiments, the step down transformer 300b, is a toroidal design, but it could equally well be a laminated design, and could be an autotransformer as well as an isolation transformer.

Still referring to FIGS. 4B and 7, in some embodiments, the coil of contactor 4 is connected to a microcontroller 7. The microcontroller 7 includes a set of instructions stored on memory for execution via hardware processors that can control aspects of charging, e.g., through actuating the contactor 4.

Referring to FIGS. 1-7, the electrical vehicle charger 100 may also include an electric vehicle charger plug assembly 5 in electrical communication with the first interface 18. In some embodiments, the electric vehicle charger plug assembly 5 includes a SAE J1772 type connector. In some embodiments, the electrical vehicle charger plug assembly 5 further includes a flexible cable 6 providing for electrical communication between the electric vehicle charger plug assembly 5 and the first interface 18.

FIGS. 1-8 further illustrate an overhead luminaire 75 mounted to the structure having the form factor of the electrical vehicle charger 100. The overhead luminaire 75 is in electrical communication with the second interface 19 that includes the 100 VAC-277 VAC output, while the EV charger connected to the first interface 18 may accept 240 VAC. However, other embodiments have been contemplated ion which the second interface 19 can provide for single-phase 120 VAC, 240 VAC, 277 VAC, 480 VAC, and 3-phase 120 VAC, 208 VAC, 240 VAC, 277 VAC, 480 VAC. An overhead luminaire 75 can be selected to have a power configuration matching any of the aforementioned examples voltage outputs for powering the luminaire 75.

The charge station 50, also referred to as electrical box is now described in more detail with reference to FIGS. 4-7. As noted, the charge station 50 is configured for level 2 charging. The charge station 50 is connected with a 240V AC circuit either by fixed wiring or via a power cord 2 with an appropriate 240V power plug.

To provide that the second interface 19 with a 100 VAC-277 VAC output, the charging station 50 includes a splitter 300a. However, as noted above, other embodiments have been contemplated in which the second interface 19 can provide for single-phase 120 VAC, 240 VAC, 277 VAC, 480 VAC, and 3-phase 120 VAC, 208 VAC, 240 VAC, 277 VAC, 480 VAC. For example, the second interface 19 may also be a component of the structure having the form factor of an electrical vehicle charger 100. This provides that both the charge station 50 and the luminaire 75 can be wired from the same connection to the power grid, and that the charge station 50 and the luminaire 75 can be integrated into the same support structure, which reduces the footprint of the space the luminaire and charge station would have occupied if installed separately.

In some embodiments, the charger station 50 of electric vehicle supply equipment device 100 includes a display 53 for charging data and a mount for reversibly engaging the electric vehicle charger plug assembly 5. The display 53 may be in electrical communication with the microcontroller 43.

In some embodiment, the display 53 may also be in communication with drivers 8 of the overhead luminaire 75. In this example, the display 53 may provide an interface through which a user can observe settings for the lighting from the overhead luminaire 75. In some embodiments, the display 53 may be in electrical communication with the driver 8 of the overhead luminaire 75n.

The display 53 may also include a number of anti-glare type structures, which can include hoods, screens, visors, etc. The point of these types of structures is to obstruct the formation of a glare on the display 53 from the sun.

Referring back to FIGS. 1-3, the second interface 19 is in electrical communication for powering the overhead luminaire 75, which can be an LED street light. An “LED street light” is an integrated light that uses light emitting diodes (LED) as its light source. In some embodiments, the LED street light is an integral unit including a light engine of solid state emitters, such as light emitting diodes (LEDs). The term “solid state” refers to light emitted by solid-state electroluminescence, as opposed to incandescent bulbs (which use thermal radiation) or fluorescent tubes, which use a low pressure Hg discharge. Compared to incandescent lighting, solid state lighting creates visible light with reduced heat generation and less energy dissipation. Some examples of solid state light emitters that are suitable for the methods and structures described herein include inorganic semiconductor light-emitting diodes (LEDs), organic light-emitting diodes (OLED), polymer light-emitting diodes (PLED) or combinations thereof. Although the following description describes an embodiment in which the solid-state light emitters are provided by light emitting diodes, any of the aforementioned solid-state light emitters may be substituted for the LEDs. As used herein, “light emitting diode (LED)” and “light emitting semiconductor structure” refer to a stack of semiconductor layers, including an active region which emits light when biased to produce an electrical current flow through the device, and contacts attached to the stack.

Still referring to FIGS. 1-3, the overhead luminaire 75 may include an LED light cluster (also referred to as an array of LEDs that provides the light engine for the luminaire) that is sealed on a panel and then assembled to the LED panel with a heat sink to become an integrated lighting fixture.

The overhead luminaire 75 may also include driver electronics 8, such as an AC-DC converter for converting the AC power from the 100 VAC-277 VAC outlet to DC power suitable for powering the light emitting diodes (LEDs) of the overhead luminaire 75. It is noted that 100 VAC-277 VAC is only one configuration that is considered for use with the electric vehicle charging structures described herein that include lighting, such as the overhead luminaire 75 and the bollard lighting 500. As noted above, other embodiments have been contemplated in which the second interface 19 can provide for single-phase 120 VAC, 240 VAC, 277 VAC, 480 VAC, and 3-phase 120 VAC, 208 VAC, 240 VAC, 277 VAC, 480 VAC. The overhead luminaire 75 may emit light having a color correlated temperature (CCT) of at least one of 2700K, 3000K, and 4000K. The luminous flux of the overhead luminaire 75 may range from 1500 lm to 12000 lm.

In some embodiments, the driver electronics 8 of the luminaire 75 include a wireless control module 9 that is in electrical communication to the driver circuit of the luminaire 75. The wireless control module 9 is connected to the driver circuit. The wireless control module 9 may provide at least one control function, such as dimming/intensity control of the light being emitted by the luminaire 75. In some other embodiments, the wireless control module 9 may provide other light control functions, such as ON/OFF switching. The wireless control module 9 may also be employed to control the color of light being emitted by the luminaire 75. In some embodiments, the wireless control module 9 may also be employed to control the color temperature of light being emitted by the luminaire 75.

The wireless control module 9 in electrical communication with the driver electronics can also provide for wireless control by the user of the function being introduced to the luminaire 75 by the wireless control module 9. To provide that the luminaire 75 is controllable through wireless communication, like Bluetooth, Wi-Fi and ZigBee, the wireless control module 9 can include an RF module to receive commands from a user terminal device, which can be provided by a phone, a tablet or even voice control device like Alexa™ and Google™ home, so that the user can control the lighting characteristics of the luminaire 75 remotely.

The wireless capabilities employed through the wireless control module 9 can be based upon IEEE 802.11, which is for wireless LANs (WLANs), also known as Wi-Fi. The 802.15 group of standards specifies a variety of wireless personal area networks (WPANs) for different applications. For instance, 802.15.1 is Bluetooth, 802.15.3 is a high-data-rate category for ultra-wideband (UWB) technologies, and 802.15.6 is for body area networks (BAN). The 802.15.4 category is probably the largest standard for low-data-rate WPANs. It has many subcategories. The 802.15.4 category was developed for low-data-rate monitor and control applications and extended-life low-power-consumption uses. The basic standard with the most recent updates and enhancements is 802.15.4a/b, with 802.15.4c for China, 802.15.4d for Japan, 802.15.4e for industrial applications, 802.15.4f for active (battery powered) radio-frequency identification (RFID) uses, and 802.15.4g for smart utility networks (SUNs) for monitoring the Smart Grid. All of these special versions use the same base radio technology and protocol as defined in 802.15.4a/b. These wireless standards can be provided to the luminaire 75 via the wireless control module 9 being wired to the driver circuit 8.

Zigbee technologies, and similar standards based on the IEEE 802 standard for networking, can be used for wireless based smart lighting control. ZigBee can be an enhancement to the 802.15.4 standard. These enhancements include authentication with valid nodes, encryption for security, and a data routing and forwarding capability that enables mesh networking. The Zigbee standard can be provided to the luminaire 75 via the wireless control module 9 being wired to the driver circuit 8.

Bluetooth Low Energy (BLE) (aka “Bluetooth smart”) is another standard in the wireless smart control business. Bluetooth low energy (BLE) is generally packaged with Bluetooth classic. The bluetooth wireless standard can be provided to the luminaire 75 via the wireless control module 9 being wired to the driver circuit 8.

Cellular standards can also be used for the wireless connectivity to the luminaire 75 from the wireless control module 9. Any cellular standard, e.g., 2G, 3G, 4G and 5G can be used with the wireless control module 9. For example, the wireless standard can be 2G, such as GSM, e.g., Circuit Switched Data (CSD), GPRS, EDGE (IMT-SC) and Evolved EDGE, Digital AMPS, e.g., Cellular Digital Packet Data (CDPD), cdmaOne (IS-95), e.g., Circuit Switched Data (CSD), and combinations thereof. In another example, the wireless standard can be 3G, such as 3GUMTS, e.g., W-CDMA (air interface), TD-CDMA (air interface) and TD-SCDMA (air interface), e.g., HSPA, HSDPA, and HSPA+ etc. In another example, the wireless standard can include CDMA2000, OFDMA (air interface), EVDO, SVDO and combinations and varieties thereof. In one example, the wireless standard employed for the wireless control module 9 is selected to work with a 4G network, such as LTE (TD-LTE), e.g., LTE Advanced and LTE Advanced Pro; WiMax, e.g., WiMAXWiMAX-Advanced (WirelessMAN-Advanced); Ultra Mobile Broadband (never commercialized); MBWA (IEEE 802.20, Mobile Broadband Wireless Access, HC-SDMA, iBurst, has been shut down); and combinations thereof. In yet another example, the wireless standard employed for the wireless control module 9 is selected to work with a 5G network, such as 5G NR or 5G-Advanced.

The lighting characteristics/lighting adjustments that are controlled by the wireless control module 9 through commands received wirelessly from a controller device. The controller device may be a mobile computing device, laptop/notebook computer, sub-notebook computer, a tablet, phablet computer; a mobile phone, a smartphone; a personal digital assistant (PDA), a portable media player (PMP), a cellular handset; a handheld gaming device, a gaming platform, a wearable computing device, a body-borne computing device, a smartwatch, smart glasses, smart headgear, and a combination thereof. In one example, the controller device may even be integrated into the display 53.

In some embodiments, to provide for mounting arrangements for the overhead luminaire 75 being integrated with the charge station 50 in the same structure, the housing includes a support pillar 31 including a first mount for the first interface 18 at a first height H1, and a second mount for the second interface 19 at a second height H2, wherein the second height H2 is greater than the first height H1. The charging station housing 50 is mounted to the support pillar 31 at the first height H1.

The luminaire 75 is connected to the second interface 19 at the cap of the support pillar 31. More specifically, in some embodiments, a luminaire support arm 76 is mounted to the support pillar 31 at a first end, wherein the luminaire 75 is mounted to the luminaire support arm 76 at an opposing second end. The luminaire support arm 76 may be a rigid tube, such as a structural hollow aluminum tube, in which a conduit for an electrical chase is present within the rigid tube and provides for electrical communication between the luminaire 75 and the second interface 19.

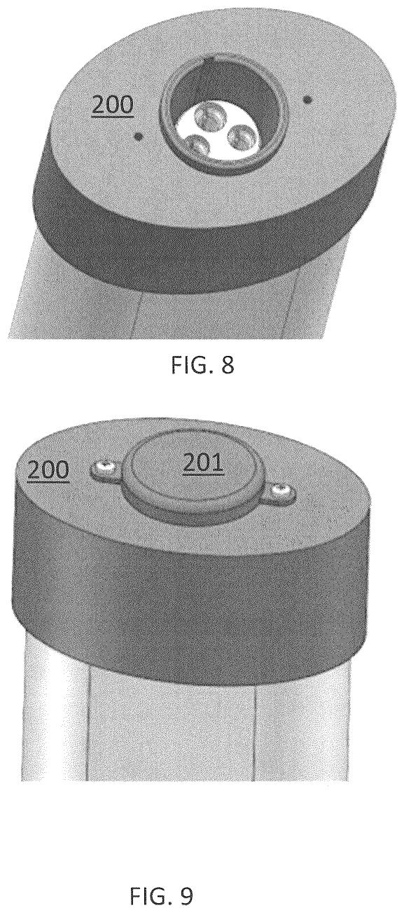

FIGS. 8 and 9 illustrates one embodiment of a socket assembly 200. The socket assembly 200 is the socket component of a plug and socket assembly that can provide the reversible engagement of the luminaire 75 (more specifically the luminaire support arm 76) to the second interface 19, which is positioned at the cap (upper surface) of the pillar support 31. FIG. 8 illustrates the socket assembly 200 that is exposed by removing the cap 201. As noted, the charger station 50 of the present disclosure does not need to be employed with the luminaire 75. In embodiments, in which the luminaire 75 is omitted, the cap 201 may be placed over the socket assembly 200 sealing it.

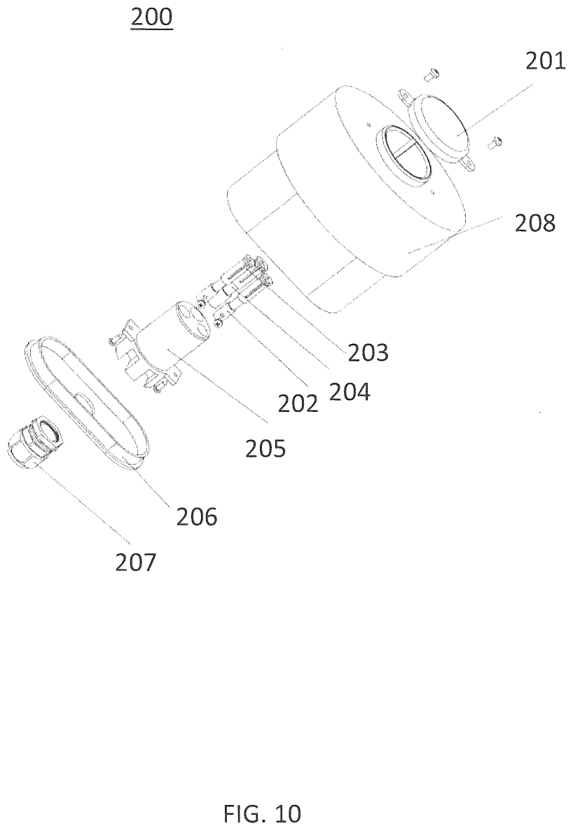

FIG. 10 illustrates the socket plug assembly module with ac power socket 200 to support the streetlight install in and obtain ac power, e.g., 120V power from the second interface 19. As discussed above, when the socket-assembly is on the disconnect with the streetlight, socket-assembly module is protected water inflow by a sealing cap 201. The socket 200 of the plug and socket assembly may include a live (L) electrode 202, a negative (N) electrode 203, and a ground (G) electrode 204. The electrodes may be housed within an electrode sleeve 205. Electrically conductive wire may pass through a connector collar 207 and protective cover 206 before the live, negative and ground wires are fastened to the live (L) electrode 202, the negative (N) electrode 203, and the ground (G) electrode 204. The electrically conductive wire may be in electrical communication with the splitter 300a, as described with reference to FIGS. 4A and 6A-6H, or the step down converter 300b, as described with reference to FIGS. 4B and 7. The electrode sleeve 205 may engage a socket housing 208 that provides the upper surface of the pillar support 31. The electrode sleeve 205 and the socket housing 208 may be composed of a plastic material having enough elasticity for engaging a plug 300 housed within the end of the end of the luminaire support arm 76.

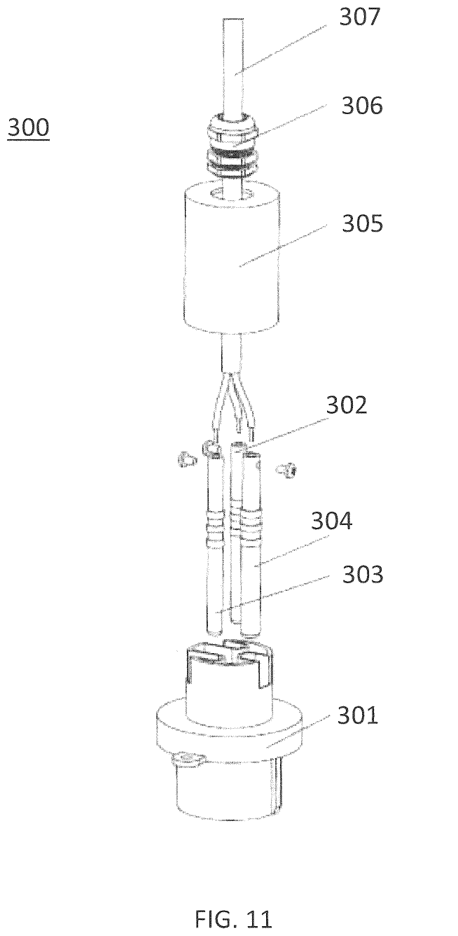

FIG. 11 is an exploded view of a plug component 300 of the socket plug assembly that is present in the end of the luminaire support arm 76 for engagement to the socket component 200 that is present in the pillar support 31 at the second interface 19. The plug component 300 may include an insulator sleeve 301, a live (L) electrode 302, a negative (N) electrode 303, ground electrode 304, a cap 305 and a connector 306. The electrodes 302, 303, 304 are housed in the insulator sleeve 301. The insulator sleeve 301 has a geometry for reversible engagement into the socket housing 208 and electrode sleeve that are integrated into the support pillar 31. The electrodes 302, 303, 304 of the plug component 300 are in direct contact with the electrodes 202, 203, 204 of the socket assembly when the luminaire support arm 76 is engaged to the pillar support 31.

The connector 306 is for engaging the three core cable 307 to the cap 305, in which the cap 305 engages the insulator sleeve 301. The engagement of these structures can provide a water tight seal to protect the electrical components from the elements of the weather.

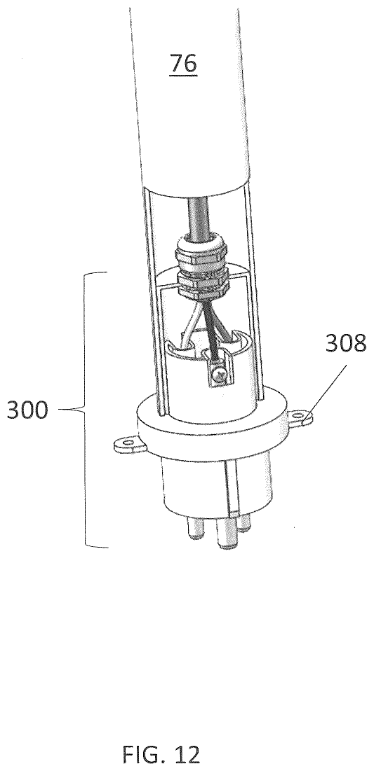

The live wire, neutral wire and ground wire of the three core cable 307 may be engaged to the live (L) electrode 302, the negative (N) electrode 303, and the ground electrode 304, respectively, as depicted in FIG. 11. FIG. 12 illustrates the plug component 300 of the socket plug assembly mounted into the end of the luminaire support arm 76. FIG. 12 further illustrates ears 308 extending from the sidewalls of the insulator sleeve 301. The ears 308 allow for mechanical connection, e.g., by fastener, such as screw and/or nut and bolt arrangements, to the socket housing 208 of the pillar support 31 depicted in FIGS. 8, 9 and 13. FIG. 12 illustrates electrical conduit for carrying the three core cable 307 within the tube structure of the luminaire arm 76 for providing electrical communication from the luminaire 75 to the plug component 300.

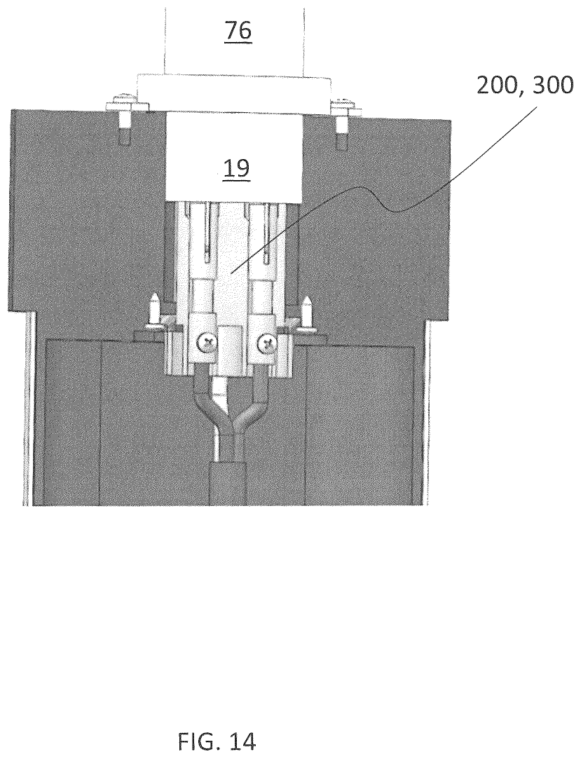

FIG. 14 illustrates one embodiment of the engagement of the plug component 300 of the socket plug assembly to the socket component 200 of the socket plug assembly illustrating engagement of the luminaire support arm 76 to the second interface 19 at the support pillar 31. To secure the engagement illustrated in FIG. 14, The engagement at the second interface 19 provides for electrical communication of the power source to the luminaire 75, which powers the light engine of light emitting diodes (LEDs) present therein to provide illumination. The engagement at the second interface 19 is reversible. By “reversible” it is meant that the luminaire assembly including the luminaire 75, luminaire support arm 76 and integrated plug component 300 may be engaged and disengaged from the socket housing 208 of the support pillar 31.

The overhead luminaire 75, e.g., street light, is only one type of illumination that can be integrated with the electric vehicle supply equipment (EVSE) of the present disclosure. In other examples, bollard illumination may be integrated with the charger station 50 of the present disclosure, as illustrated in FIGS. 15-21.

FIGS. 15 and 16 illustrate some embodiment of electric vehicle supply equipment (EVSE) including an integrated bollard luminaire 500. For example, the electric vehicle supply equipment device may include a structure having a form factor fitting a charging station including a first interface 18 for charging electric vehicles and a second interface 21 for powering a bollard luminaire. The first interface 18 including a voltage for supporting level 2 charging, and the second interface 19 is for powering the luminaire 500. In some examples, the electrical box 50 mounted to the structure that includes a connection to grid power 2, the electrical box includes an AC circuit, wherein a splitter 300a, as described with reference to FIG. 4A and FIGS. 6A-6H, provides for electrical communication from the AC circuit to the first and second interface 18, 19. The splitter 300a provides for splitting the neutral and line cables of the AC input into two branches b1, b2, wherein a first branch b1 of neutral and line cables provide electrical communication to the first interface having the voltage for supporting level 2 charging, and a second branch b2 of neutral and line cables provide electrical communication to the second interface 19 for powering the bollard luminaire 500; and an electric vehicle charger plug assembly 5 in electrical communication with the first interface 18, wherein the bollard luminaire 500 is mounted to the housing and is in electrical communication with the second interface 19.

In some embodiments, the electric vehicle supply equipment (EVSE) comprises a charging station housing 50 including one interface 18 for charging electric vehicles and at a second interface 21 for powering a bollard luminaire 500, wherein the first interface 18 includes 240V outlet and the second interface 21 includes a 100 VAC-277 VAC outlet. In other embodiments, second interface 21 can provide for single-phase 120 VAC, 240 VAC, 277 VAC, 480 VAC, and 3-phase 120 VAC, 208 VAC, 240 VAC, 277 VAC, 480 VAC.

It is noted that the step down converter 300b that has been described with reference to FIGS. 4B and 8 may be substituted for the splitter 300a.

The charging box 50 illustrated in FIGS. 15 and 16 is similar to the charging box 50 that has been described above with respect to FIGS. 1-14. For example, the charging box 50 that is depicted in FIGS. 15-21 includes a connection to grid power 2, and a contactor 4, and a splitter 300a. The splitter 300a provides for electrical communication from the AC circuit to the first and second interface 18, 19. The splitter 300a provides for splitting the neutral and line cables of the AC input into two branches b1, b2, wherein a first branch b1 of neutral and line cables provide electrical communication to the first interface having the voltage for supporting level 2 charging, and a second branch b2 of neutral and line cables provide electrical communication to the second interface 19 for powering the bollard luminaire 500. The electric vehicle plug assembly 5 is in electrical communication with the first interface 18.

In some embodiments, the bollard luminaire 500 may also be integrated with overhead luminaires 75, in addition to the electrical charger, e.g., electrical plug 5. In some embodiments, the multiple luminaires may include a bollard luminaire 500 that engages an interface 21 at the sidewall of the housing, e.g., sidewall of the charger station 50; and an overhead luminaire 75 (as described with reference to FIGS. 1-14) that can engage an interface 19 positioned at the top of the pillar support 31. The interface 19 at the top of the pillar support 31 may also provide a 100 VAC-277 VAC outlet. In other embodiments, interface 19 can provide for single-phase 120 VAC, 240 VAC, 277 VAC, 480 VAC, and 3-phase 120 VAC, 208 VAC, 240 VAC, 277 VAC, 480 VAC. This has also been described with reference to FIGS. 1-14. Both the interface 19 at the top of the pillar support 31 and the interface 21 at the sidewall of the housing, e.g., at the sidewall of the charger station 50, may be sealed with a plug 301, 501 when not in use.

As described with reference to FIGS. 1-14, in the embodiments including the bollard illumination 500, when also employing an overhead luminaire 75, e.g., street light, the overhead luminaire 74 is mounted to an upper surface of the luminaire support pillar 31 having electrical communication with an interface 19 that includes the outlet, e.g., 100 VAC-277 VAC outlet, for powering the overhead luminaire. The overhead luminaire 75 is mounted to the luminaire support pillar 31 through a luminaire support arm 76, wherein a two piece electrical socket having positive electrode, negative electrode and ground contacts having a first connector integrated into a cap of the luminaire support pillar 13 provides the interface with electrical communication to the splitter 300a.

It is noted that the step down converter 300b that has been described with reference to FIGS. 4B and 8 may be substituted for the splitter 300a.

Referring to FIG. 15, the electric vehicle supply equipment (EVSE) may include a bollard luminaire 500 mounted to a sidewall of the structure having the form factor of a charging station, and including electrical communication with the second interface 21 that includes the 120V outlet for powering the luminaire. In the embodiment depicted in FIG. 15, the bollard luminaire 500 can engage the sidewall of the charging station housing 50.

The bollard luminaire 500 that is depicted in FIG. 15 is similar to the overhead luminaire 75 that is described above with reference to FIGS. 1-14. In some embodiments, the bollard luminaire 500 includes a light engine of light emitting diodes (LEDs). Further, the light emitting didoes (LEDs) may be energized by driver electronics 8. The LEDs of the light engine may have adjustable lighting characteristics. Similar to the overhead luminaire 75, the lighting characteristics of the bollard luminaire 500 may be adjusted and viewed through the display 53.

Additionally, the lighting characteristics of the bollard luminaire 500 may be adjusted wirelessly. For example, the driver electronics 8 of the bollard luminaire 500 may include a wireless control module 9 that is in electrical communication to the driver circuit of the bollard luminaire 500. The wireless control module 9 is connected to the driver circuit. The wireless control module 9 may provide at least one control function, such as dimming/intensity control of the light being emitted by the bollard luminaire 500. In some other embodiments, the wireless control module 9 may provide other light control functions, such as ON/OFF switching. The wireless control module 9 may also be employed to control the color of light being emitted by the bollard luminaire 500. In some embodiments, the wireless control module 9 may also be employed to control the color temperature of light being emitted by the bollard luminaire 500.

The wireless control module 9 in electrical communication with the driver electronics can also provide for wireless control by the user of the function being introduced to the bollard luminaire 500 by the wireless control module 9. To provide that the bollard luminaire 500 is controllable through wireless communication, like Bluetooth, Wi-Fi and ZigBee, the wireless control module 9 can include an RF module to receive commands from a user terminal device, which can be provided by a phone, a tablet or even voice control device like Alexa™ and Google™ home, so that the user can control the lighting characteristics of the bollard luminaire 500 remotely.

The wireless capabilities employed through the wireless control module 9 can be based upon IEEE 802.11, which is for wireless LANs (WLANs), also known as Wi-Fi. The 802.15 group of standards specifies a variety of wireless personal area networks (WPANs) for different applications. For instance, 802.15.1 is Bluetooth, 802.15.3 is a high-data-rate category for ultra-wideband (UWB) technologies, and 802.15.6 is for body area networks (BAN). The 802.15.4 category is probably the largest standard for low-data-rate WPANs. It has many subcategories. The 802.15.4 category was developed for low-data-rate monitor and control applications and extended-life low-power-consumption uses. The basic standard with the most recent updates and enhancements is 802.15.4a/b, with 802.15.4c for China, 802.15.4d for Japan, 802.15.4e for industrial applications, 802.15.4f for active (battery powered) radio-frequency identification (RFID) uses, and 802.15.4g for smart utility networks (SUNs) for monitoring the Smart Grid. All of these special versions use the same base radio technology and protocol as defined in 802.15.4a/b. These wireless standards can be provided to the bollard luminaire 500 via the wireless control module 9 being wired to the driver circuit 8.

Zigbee technologies, and similar standards based on the IEEE 802 standard for networking, can be used for wireless based smart lighting control. ZigBee can be an enhancement to the 802.15.4 standard. These enhancements include authentication with valid nodes, encryption for security, and a data routing and forwarding capability that enables mesh networking. The Zigbee standard can be provided to the bollard luminaire 500 via the wireless control module 9 being wired to the driver circuit 8.

Bluetooth Low Energy (BLE) (aka “Bluetooth smart”) is another standard in the wireless smart control business. Bluetooth low energy (BLE) is generally packaged with Bluetooth classic. The bluetooth wireless standard can be provided to the bollard luminaire 500 via the wireless control module 9 being wired to the driver circuit 8.

Cellular standards can also be used for the wireless connectivity to the bollard luminaire 500 from the wireless control module 9. Any cellular standard, e.g., 2G, 3G, 4G and 5G can be used with the wireless control module 9. For example, the wireless standard can be 2G, such as GSM, e.g., Circuit Switched Data (CSD), GPRS, EDGE (IMT-SC) and Evolved EDGE, Digital AMPS, e.g., Cellular Digital Packet Data (CDPD), cdmaOne (IS-95), e.g., Circuit Switched Data (CSD), and combinations thereof. In another example, the wireless standard can be 3G, such as 3GUMTS, e.g., W-CDMA (air interface), TD-CDMA (air interface) and TD-SCDMA (air interface), e.g., HSPA, HSDPA, and HSPA+ etc. In another example, the wireless standard can include CDMA2000, OFDMA (air interface), EVDO, SVDO and combinations and varieties thereof. In one example, the wireless standard employed for the wireless control module 9 is selected to work with a 4G network, such as LTE (TD-LTE), e.g., LTE Advanced and LTE Advanced Pro; WiMax, e.g., WiMAX WiMAX-Advanced (WirelessMAN-Advanced); Ultra Mobile Broadband (never commercialized); MBWA (IEEE 802.20, Mobile Broadband Wireless Access, HC-SDMA, iBurst, has been shut down); and combinations thereof. In yet another example, the wireless standard employed for the wireless control module 9 is selected to work with a 5G network, such as 5G NR or 5G-Advanced.

The lighting characteristics/lighting adjustments that are controlled by the wireless control module 9 through commands received wirelessly from a controller device. The controller device may be a mobile computing device, laptop/notebook computer, sub-notebook computer, a tablet, phablet computer; a mobile phone, a smartphone; a personal digital assistant (PDA), a portable media player (PMP), a cellular handset; a handheld gaming device, a gaming platform, a wearable computing device, a body-borne computing device, a smartwatch, smart glasses, smart headgear, and a combination thereof. In one example, the controller device may even be integrated into the display 53.

The bollard luminaire 500 includes a light engine of light emitting diodes (LEDs). For example, the bollard luminaire 500 may emit light having a color correlated temperature (CCT) of at least one of 2700K, 3000K, and 4000K. The luminous flux of the bollard luminaire 500 may range from 1500 lm to 12000 lm. The electric vehicle supply equipment device depicted in FIG. 15 may further include a luminaire support pillar, wherein the charging station housing is mounted to the luminaire support pillar 502.

The electric vehicle supply equipment (EVSE) may include that the bollard luminaire 500 that is mounted to the sidewall of the housing and is in electrical communication with the step down converter 300b by a first connector of the socket assembly 600 integrated into the sidewall of the charge station housing 50 having positive electrode 602, negative electrode 603 and ground contacts 604 that provides the second interface 21, as depicted in FIGS. 15-21.

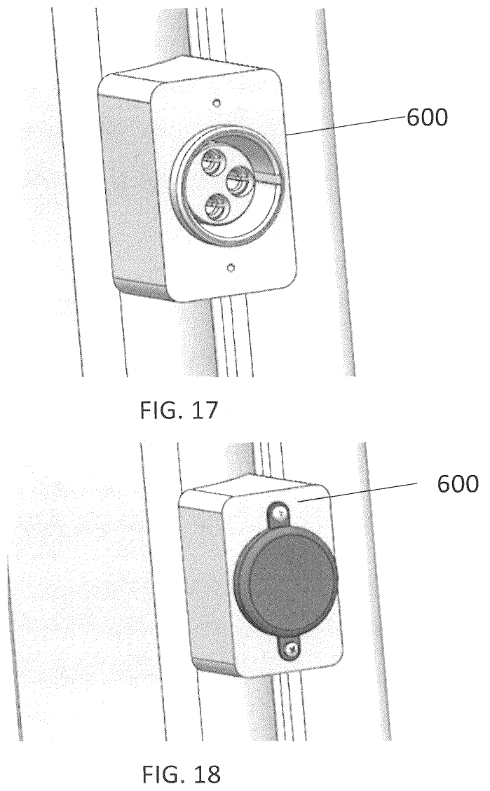

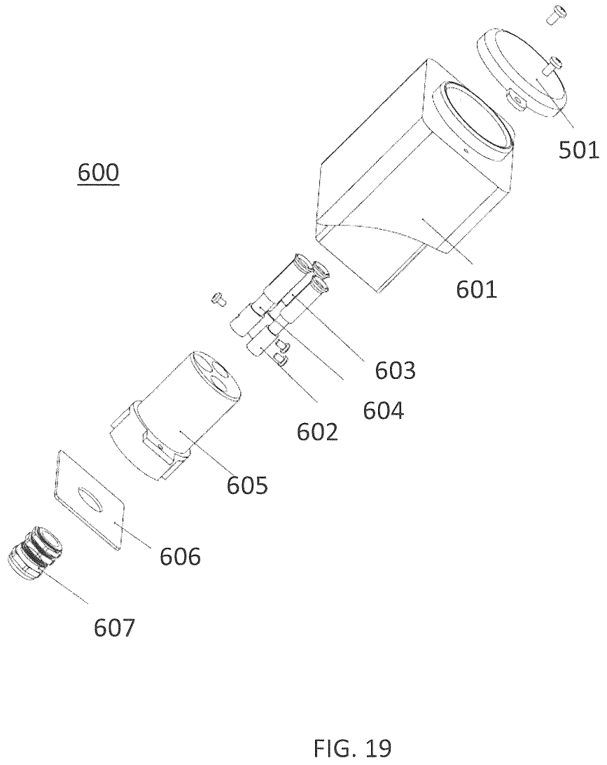

FIG. 17 illustrates a socket component 600 for an interface for powering the bollard illumination 500, in which the socket assembly 600 is integrated into the sidewall of the charging station housing 50. In FIG. 17, the sealing cap 501 is removed and the electrodes, i.e., positive electrode 602, negative electrode 603 and ground contacts 604, are exposed. FIG. 18 illustrates the socket component 600 that is illustrated in FIG. 17, in which the sealing cap 501 is mounted on the socket opening. FIG. 19 is an exploded view of the socket component that is depicted in FIG. 17. The socket-assembly is consisted by sealing cap, socket housing, nature electrode, ground electrode, live electrode, insulate sleeve, protect cover, connector (FIG. 15). The live electrode, nature electrode and ground electrode is made by high conductive material (such as copper, brass), three electrodes embedded in the insulate sleeve, and they have enough elasticity to clamp the corresponding electrodes on the plug-assembly. FIG. 15 display the socket-assembly and plug-assembly couple together process.

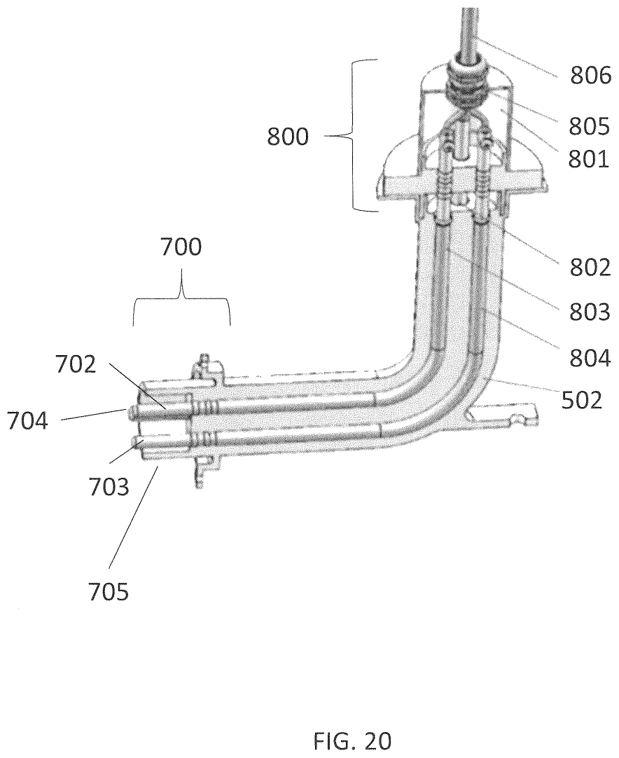

FIG. 20 of a bollard support arm 502 having a plug component integrated 700 therein for engagement to the socket component 600 that is depicted in FIG. 17. The bollard luminaire 500 is mounted to the sidewall of the charging station housing 50 through a bollard luminaire support arm 502 having a connector of the socket assembly 600, 700 in reversible electrical communication between the second interface 21 and a bollard LED light engine of the bollard luminaire 500 at the opposite end of the bollard luminaire support arm 502.

Referring to FIG. 20, the plug component 700 is a transfer assembly component, and it can convert the ac power from socket-assembly into a way fit to bollard luminaire 500. For example, at some point, whether it be in the bollard support arm 502 of the bollard luminaire 500, driver electronics are present for converting the AC power from the interface 21 to DC power suitable for powering the LEDs of the bollard luminaire 500 for the purposes of emitting light. In some embodiments, the plug component 700 includes an embedded live (L) electrode 702, negative (−) electrode 703, and ground electrode 705 in a insulate material housing, e.g., connector 705. Still referring to FIG. 20, the bollard support arm houses a cable 806 having one end connected to the electrodes 703, 703, 704 of the plug component 700 that contact the electrodes 602, 603, 604 of the socket component 600 when the plug and socket components 600, 700 are engaged to one another, as depicted in FIG. 20.

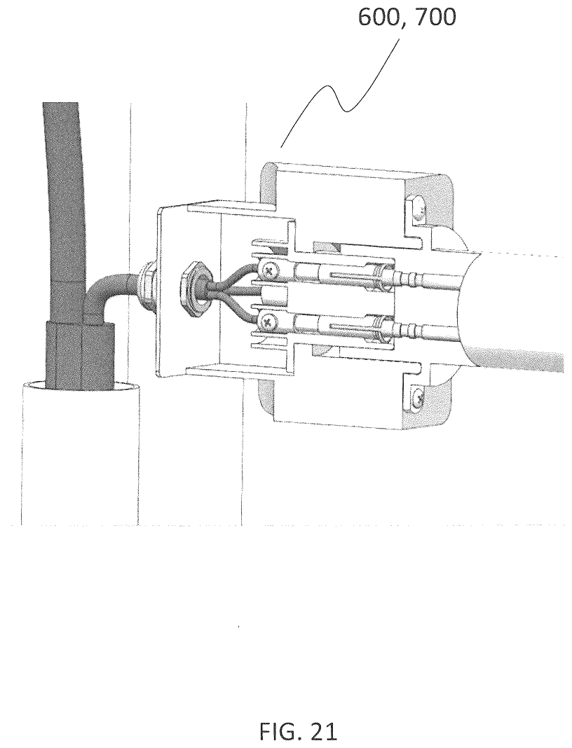

The other end of the bollard support arm 502 provides for engagement of the wire leading to the light engine of the bollard luminaire 500. The connector 800 at the opposing end of the bollard support arm 502 from the end including the plug component 700 may include a ground electrode 804, live electrode 802, and negative electrode 803 that are housed in a protective cover 801. The protective cover 801 has a geometry for reversible engagement to the bollard luminaire 500. In some embodiments, under the protective cover 801, the wires providing electrical communication from the interface 21 across the bollard support arm 502 to power the bollard luminaire 500 through connection via connector 800 are engaged to the electrodes 802, 803, 804 with fastener arrangements, such as nut and bolt arrangements and/or screws. Solder connection may also be employed. The wire 806 extends through the protective cover 801, in which a connector 805 having an annular geometry provides for a seal between the wire 806 that extends through the annular opening of the connector 805 and the protective cover 801. The connector 800 allows for reversible engagement of the bollard luminaire 500 to the bollard support art. The plug component 700 at the opposing end of the bollard support arm 502 may engage the socket component 600 at the interface 21 providing the power, e.g., 100 VAC-277 VAC, that powers the LEDs in the bollard luminaire 500 to emit light. The plug component 700 may be fastened to socket component 600 by nut and bolt arrangements and/or screws as depicted in FIG. 21. In some embodiments, one or more stand-bolts engaged to the luminaire support arm 502 can provide additional support for the bollard luminaire 500, as depicted in FIGS. 15 and 16.

In one embodiment, the structures described above may be employed in a method for providing lighting. The following description for a method employs a splitter 300a, as described with reference to FIGS. 4A and 6A-6H. In one embodiment, the method of providing lighting for a charging station includes providing a charging station housing 50 having a first interface 18 including a voltage for supporting level 2 charging and a second interface 19 for powering a luminaire 75. For example, the luminaire 75 may accept 100 VAC-277 VAC, which is provided by the second interface 19; while the EV charger may accept 240 VAC, which is provided by the first interface 18. However, other embodiments can provide for single-phase 120 VAC, 240 VAC, 277 VAC, 480 VAC, and 3-phase 120 VAC, 208 VAC, 240 VAC, 277 VAC, 480 VAC. In each of the above configurations, any of the 2 input wires, regardless of voltage (or phase) can be split into 2 to be fed into the EV chargers and the luminaire, e.g., overhead luminaire and/or bollard luminaire.

The method further includes connecting an electrical box 50 for the charging station to grid power 2 that includes a 240V AC circuit, wherein the electrical box includes an 240V contactor 4 in electrical communication with the 240V AC circuit, and a splitter 300a in electrical communication with the 240V contactor 4 for providing the power for powering the luminaire 75.

The method may further include installing a plug 5 or engaging the charging point of an electric vehicle to the first interface 18; and mounting the luminaire 75 to the charging station housing having electrical communication with the second interface 19. The luminaire 75 is an overhead luminaire 75, such as a street light luminaire including a light emitting diode (LED) light engine.

In some embodiments, the method may further include installing a third interface 21 in electrical communication with the splitter 300a, and engaging a bollard luminaire 500 to the third interface 21. The third interface 21 is on a sidewall of the charging station housing.

In one embodiment, the structures described above may be employed in a method for providing lighting. The following description for a method employs a step down converter 300b, as described with reference to FIGS. 4B and 7. In one embodiment, the method of providing lighting for a charging station includes providing a charging station housing 50 having a first interface 18 for electric vehicle (EV) charging at 240V and a second interface 19 for powering a luminaire 75 that is mounted to the charging station housing for powering at 120V. The method further includes connecting an electrical box 50 for the charging station to grid power 2 that includes a 240V AC circuit, wherein the electrical box includes an 240V contactor 4 in electrical communication with the 240V AC circuit, and a step down converter 300b in electrical communication with the 240V contactor 4 for providing the 120V power for powering the luminaire 75. The step down converter 300b may be a transformer selected from the group consisting of a toroidal transformer, a laminated transformer and combinations thereof.

The method may further include installing a plug 5 or engaging the charging point of an electric vehicle to the first interface 18; and mounting the luminaire 75 to the charging station housing having electrical communication with the second interface 19. The luminaire 75 is an overhead luminaire 75, such as a street light luminaire including a light emitting diode (LED) light engine.

In some embodiments, the method may further include installing a third interface 21 in electrical communication with the step down converter 300b, and engaging a bollard luminaire 500 to the third interface 21. The third interface 21 is on a sidewall of the charging station housing.

The method may further include an installation sequence that allows for later adding a luminaire 75. The luminaire 75 may be an overhead luminaire and/or bollard luminaire, in which electrical power may be provided to the luminaire using a splitter 300a, as described above with reference to FIG. 4A and FIGS. 6A-6H. Although not specifically depicted in the supplied figures, in some embodiments, the method for adding a luminaire 75 into the following described modular assemblies may also employ a step down converter 300b, as depicted in FIG. 4B and FIG. 7, which can be substituted for the splitter.

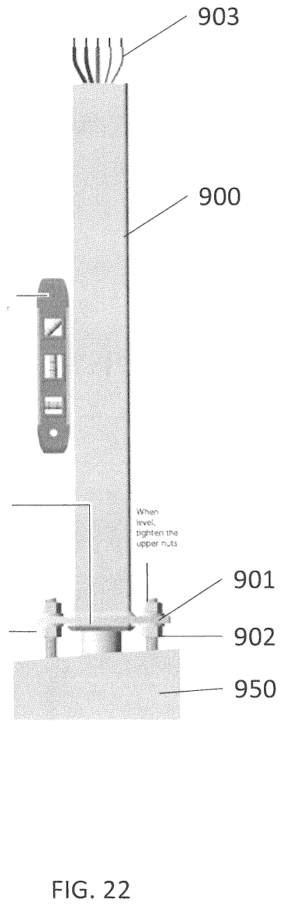

First, a process flow is described with reference to FIGS. 22-26 for mounting the supporting structure, e.g., body, of an electrical vehicle charger that does not include a luminaire 75. This process flow is providing electric vehicle supply equipment (EVSE) 1000, e.g., electrical vehicle charger, without including a luminaire 74, as described above with reference to FIGS. 1-21. However, components of this process flow can be reused in a retrofit method for installing a luminaire to an electrical charger.

FIG. 22 illustrates mounting a pole and base plate assembly 900 for the mounting structure to a concrete base 950 including fasteners 902. The pole and base plate assembly may be a rigid metal structure that provides the anchor for the electric vehicle supply equipment (EVSE) 1000, e.g., electrical vehicle charger. The base plate assembly 901 is a metal plate having holes present therethrough for accepting fasteners 902 that are fixed into the concrete base 950. By adjusting the torque and using spacers, of the nut and bolt arrangements used to fasten the pole and base plate assembly to the fasteners 902 that are embedded in the concrete base 950, the pole may be adjusted to provide a level structure to which the electric vehicle supply equipment (EVSE) 1000, e.g., electrical vehicle charger, is assembled. Note there is no separate conduit for luminaire wiring at this stage.

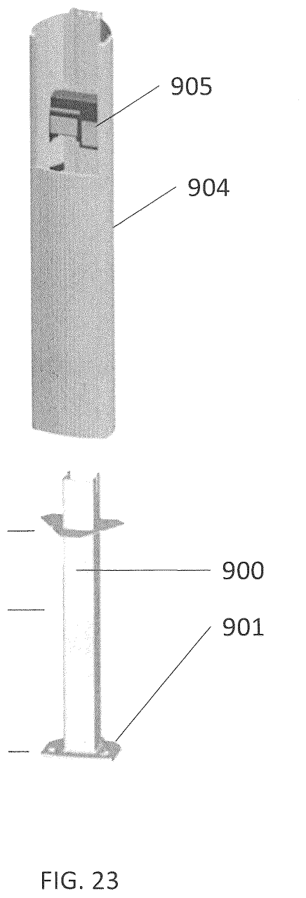

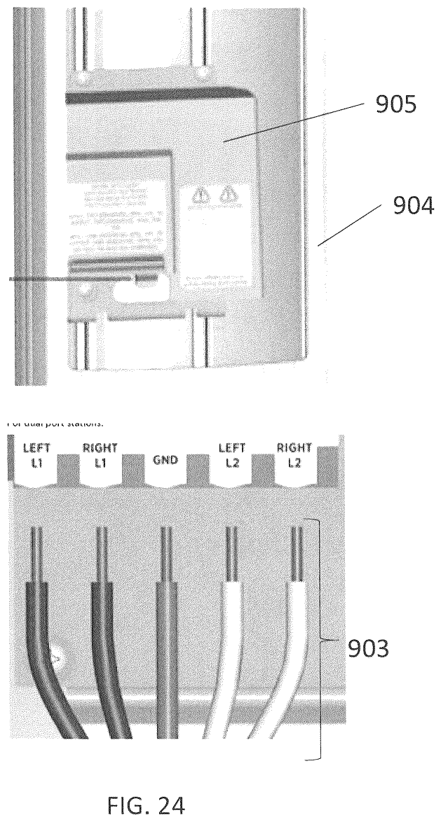

FIG. 23 illustrates mounting a main body 904 to the pole and base plate assembly 900. As illustrated in FIG. 23, the main body 904 slides over the pole and base plate assembly 900. Further, the main body 904 includes an electrical box 905 for mounting an electric vehicle charger, and for wiring the power source (wiring 903), e.g., AC input 2, as described above with reference to FIGS. 1-21. The main body 904 may be a metal walled or rigid plastic walled surface configured to enclosure internal electronics including wiring and wiring conduit. FIG. 24 view illustrating wiring the electrical box 905. In this example, the wiring 903 is for two electric vehicle plugs 5. However, this is only one example, and the present disclosure is not limited to only this example. For example, embodiments have been contemplated in which one a single electric vehicle plug 9 is employed.

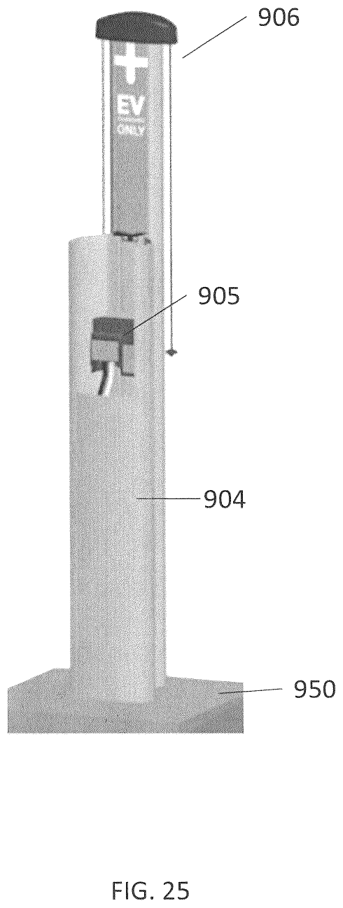

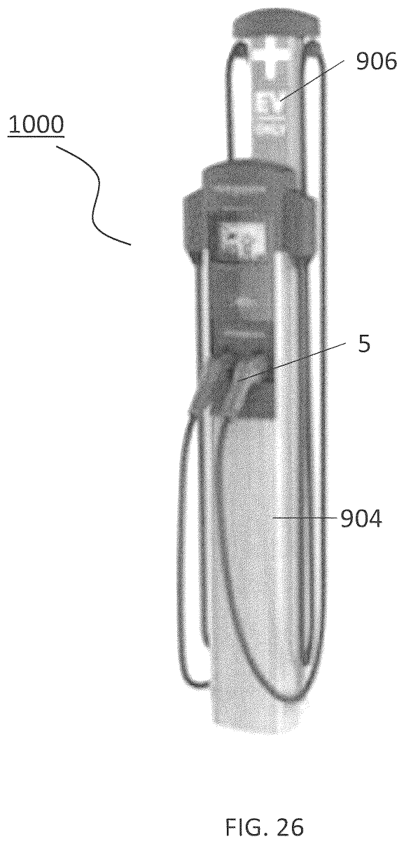

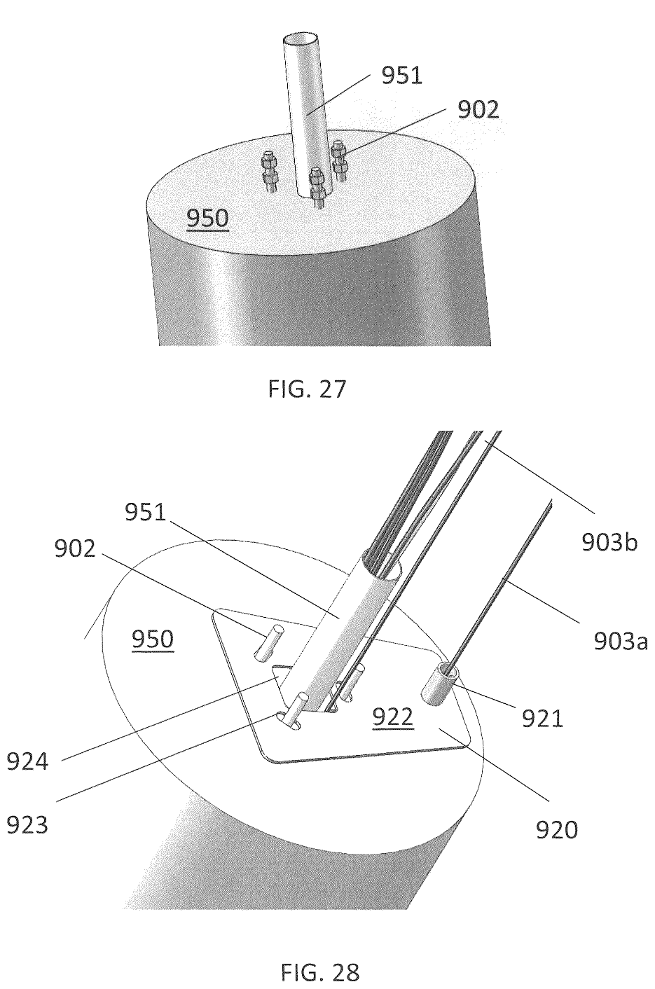

FIG. 25 illustrates a cable management structure/retractor 906 assembled to the main body 904. This cable management structure may control the cables for the electric vehicle plugs 5, for the embodiment depicted in FIGS. 22-26. FIG. 26 illustrates one embodiment, of an electric vehicle supply equipment (EVSE) 1000, e.g., electrical vehicle charger, assembled using the structures that were assembled in accordance with FIGS. 22-25. The electric vehicle charger in this example includes two electric vehicle plugs 5 that are in a charger structure that is engaged to the electrical box 905 that is within the main body 904. It is noted that the example depicted in FIGS. 22-25 does not include a luminaire 75. However, a luminaire 75, such as an overhead luminaire may be retrofit assembled to a similar structure that is formed on the same concrete base, as described with reference to FIGS. 27-37.

First, the electric vehicle supply equipment (EVSE) 1000, e.g., electrical vehicle charger, that is depicted in FIGS. 22-26 is deconstructed down to the concrete base 950 and fasteners 902 that are fixed to the concrete base, as depicted in FIG. 27. Also depicted in FIG. 27 is a main conduit 951 to the electrical box 905 for the electrical vehicle charger that is housed in the main body 904. The conduit 951 may be a cylindrical base conduit having a diameter that is accepted within the main body 904. For example, the main body 904 may have a conduit for the wiring 903 to bring the wiring 903 to the location of the electrical box 905. As illustrated in FIGS. 1-3, the overhead street luminaire 75 is mounted to the upper surface of the cable management structure/retractor 906, which is a separate structure from the main body 904. As noted above, the wiring the power source (wiring 903), e.g., AC input 2, may brought to the electrical box 905 in the main body 904, and at that point, the wiring 903 may be split using a splitter 300a, as described with reference to FIGS. 4A, 6A-6H and 34, in which one branch provides power to the EV charger, e.g., ultimately providing power to the EV charger plug 5, and the second branch provides power for the luminaire 75. In other embodiments, the splitter 300a may be substituted with a step down transformer 300b, as described with reference to FIGS. 4B and 7.

FIGS. 28-33 illustrate a base adapter 920 composed of welded rigid metal including mounting openings 923 for the fasteners 902 to engage the pole and base plate assembly 900, an opening 924 for main conduit 951, and an integral conduit 921 for the wiring to the luminaire 75.

The base adapter 920 bolts to the concrete base 950 and provides a wiring passageway identified by reference number 924 for the wiring from the main conduit 951 to the electrical box 905 in the main body, and also provides a wiring passageway from the integral conduit 921 to the luminaire 75. Using this adapter, electrical communication may be provided for the power source (wiring 903), e.g., AC input 2, to be brought to the electrical box 905, where a split occurs, and then to the luminaire 75.

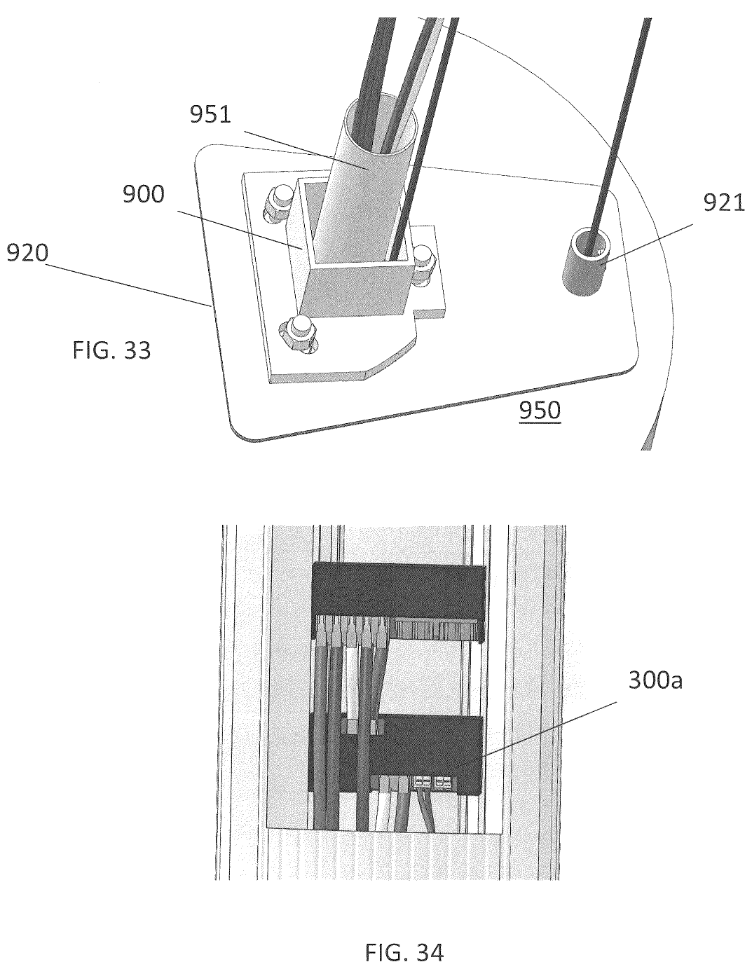

The base adapter 920 includes a substantially planar base 922. The substantially planar base 922 may be composed of a rigid metal, such as metal plate or sufficiently thick metal sheet. The substantially planar base 922 has mounting openings 923 present therethrough corresponding to the location of the fasteners 902 that the pole and base plate assembly bolt to. More particularly, during assembly, the base adapter 920 is first placed directly on the concrete base 950 with the fasteners 902 that are fixed to the concrete base extending through the mounting openings 923 in the substantially planar base 922 of the adapter 920. The pole and base plate assembly 900 is then placed atop the base adapter with the fasteners 902 extending through the holes in the base of the pole and base plate assembly 900. As the bolts are threaded and torqued onto the fasteners 902 the pole and base plate assembly is clamped to the concrete base 950 with the adapter 920 being positioned between the concrete base 950 and the pole and base plate assembly 900. This is illustrated in FIGS. 32 and 33.

As noted, the substantially planar base 922 includes a wiring passageway 924 for the wiring 903 from the main conduit 951 in the concrete base 950 to extend to the electrical box 905 and to be passed through the main body 904 to travel to the electrical box 905. Once split, e.g., at a splitter 300a, the branch for the luminaire 75, extends back to the base of the main body 904 and then through the base adapter 920 to travel to the integral conduit, and then to extend to the luminaire 75 that is positioned at an upper surface of the cable management structure/retractor 906.

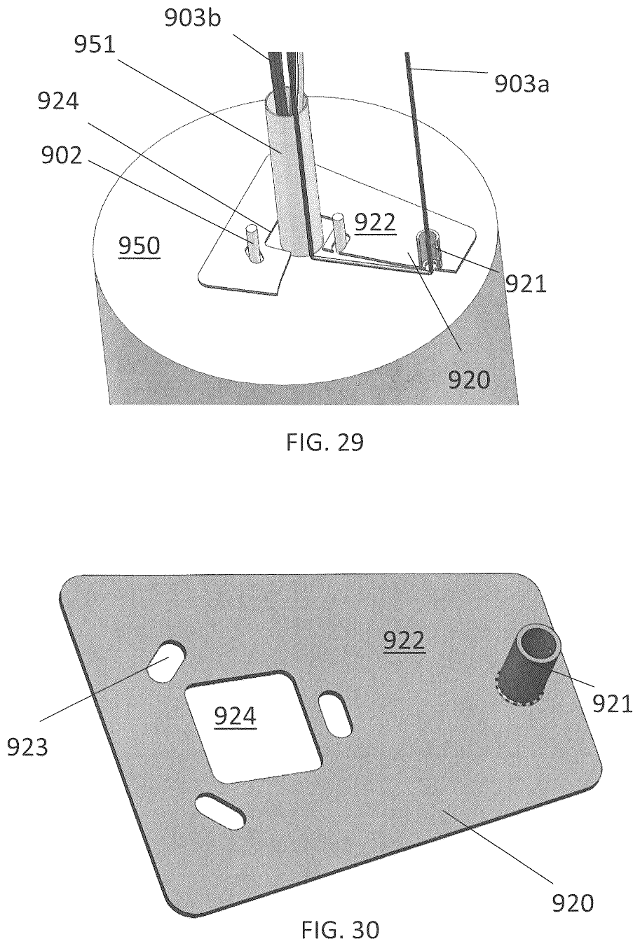

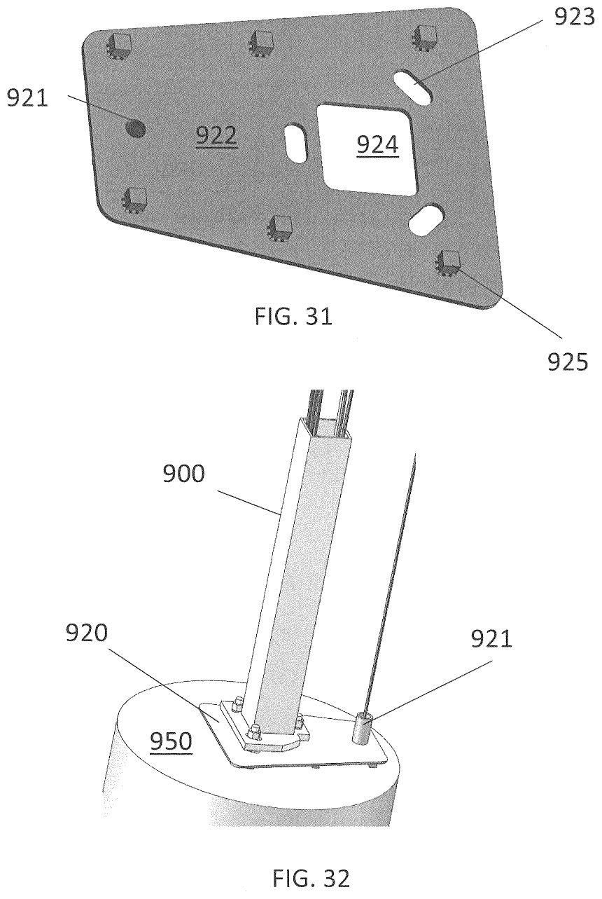

The integral conduit 921 of the base adapter 920 extends upward from the upper surface of the planar base 922. The integral conduit 921 is welding to the plate metal of the planar base 922 on the upper surface. The backside surface of the planar base 922 includes vertical offset stanchion posts 925, as depicted in FIG. 31. The height of the vertical offset stanchion posts 925 is selected so that wiring 903, e.g., the wiring branch 903b that is traveling to the luminaire 75, may pass between the backside surface of the planar base 922 and the upper surface of the concrete base 950. This is illustrated by comparing FIG. 28 to FIG. 29. FIG. 28 illustrates the base adapter 920 composed of welded metal including mounting points for the pole and base plate assembly 900, an opening 923 for main conduit 951, and an integral conduit 921 for wiring to a luminaire. FIG. 29 is a sectioned view of the base adapter 920 mounted to the concrete base 950 that is depicted in FIG. 28. FIG. 29 is sectioned to illustrated the path of the branch 903b for the wiring that is extending from the splitter 300a/step down converter 300b that is in the main body 904, across the base adapter 920 from the opening 923 for the main conduit 951 to the opening into the integral conduit 921 for passing the branch to the luminaire 75, e.g., through passageways extending through the cable management structure/retractor 906.

As noted above, the wiring first travels to the splitter 300a/step down converter 300b in the main body 904. Once the wiring is split to provide a branch 903b to the luminaire 75, the branch for the luminaire 903b travels from the splitter 300a/step down converter 300b to back to the base of the main body 904 (and is some examples may also travel back through the main conduit 951). The integral conduit 921 for the luminaire wiring 903b is laterally offset from the main conduit 951, as illustrated in FIG. 29. For example, as illustrated in FIGS. 1-3 the luminaire 75 is mounted to the upper surface of the cable management structure/retractor 906, which is a separate structure from the main body 904.

FIG. 32 illustrates base adapter 920 as depicted in FIGS. 30 and 31 mounted to the concrete base 950, and a pole and base plate assembly 900 mounted to the base adapter 920. FIG. 33 is a sectioned view of the base adapter 920 mounted to the concrete base 950, and a pole and base plate assembly mounted 900 to the base adapter 920 that is depicted in FIG. 32. A portion of the wiring 903a is illustrated coming out of the main conduit 951 through the wiring passageway 924 in the planar base 922 of the base adapter for the wiring 903 from the main conduit 951 to extend to the electrical box 905 in the main body 904. A portion of wiring 903b is illustrated extending back from a splitter 300a/step down converter 300b in the main body 904, through the wiring passageway 924 in the planar base, and then traveling laterally across the width of the planar base 922 and extending into the integral conduit 921 for the luminaire 75. The wiring 903b enters the integral conduit 921 from the backside of the planar base 922 exiting through integral conduit on the upper surface side of the planar base 922, and extending toward the luminaire, which can be mounted at the top of the upper surface of the cable management structure/retractor 906.

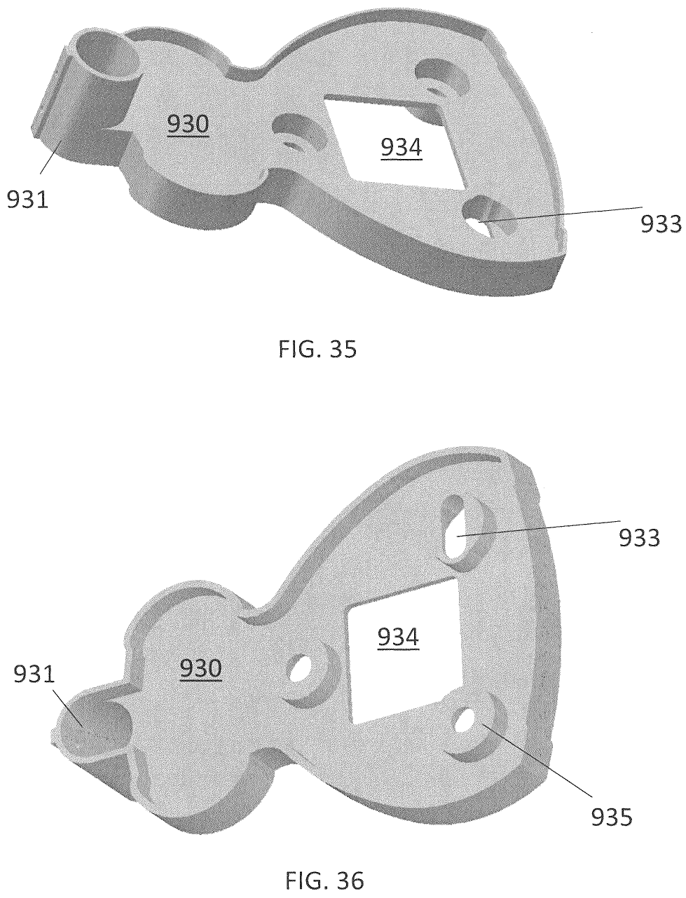

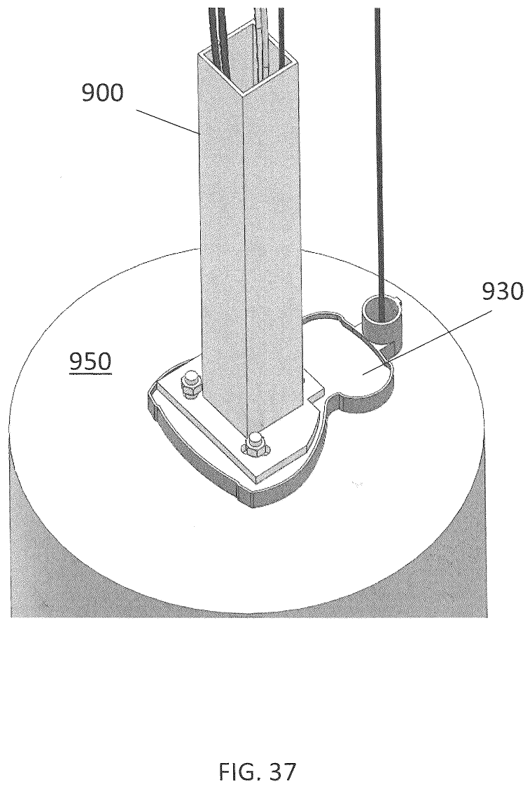

It is noted that the base adapter 920 does not have to be composed of a welded metal assembly. FIGS. 35-37 illustrate another embodiment of a cast base adapter 930. By cast is it meant the structure is case of metal. For example, the cast base adapter 930 may be die cast. However, any casting method may be suitable for forming the embodiment of the base adapter that is depicted in FIGS. 35-37. FIG. 35 is view of an upper surface of a base adapter 930 composed of cast metal. FIG. 36 is a view of a backside surface of a base adapter 930 composed of cast metal. Similar to the embodiment described with reference to FIGS. 27-33, the case embodiment also includes an integral conduit for wiring that is intended to extend to the luminaire 75, which is identified in FIGS. 35-37 by reference number 931. The base adapter 930 also includes a planar base surface. Extending through the base surface is a wiring passageway in the planar base through which the main conduit 951 passes. This opening is identified by reference number 934 and is similar to the opening identified by reference number 924 in FIGS. 27-33. The base adapter also includes openings for engaging the fasteners 902 that are fixed to the concrete base 950. These openings are identified by reference number 933. The openings identified by 933 are integral with vertical offset stanchion posts 935. The vertical offset stanchion posts 935 are functionally equivalent to the stanchion posts identified by reference number 925 in FIGS. 27-33. One difference between these embodiments is that the stanchion posts identified by reference number 925 are welded to the planar base identified by reference number 922 in FIGS. 27-33, while the station posts identified by reference number 935 are unitary cast structures with the remainder of the elements depicted in FIGS. 35 and 36. FIG. 37 is a perspective view of the base adapter as depicted in FIGS. 35 and 36 mounted to the concrete base 950, and a pole and base plate assembly 900 mounted to the base adapter 930.

Following the assembly state depicted in FIGS. 32 and 33, the wiring may be wired to the electrical box 905, spitter 300A/step down converter 300B, as the main body 904 is assembled to the base plate and assembly 900. The cable management structure/retractor 906 is then mounted, with the wiring branch 903b extending to the luminaire 75 that is positioned at an upper surface of the cable management structure/retractor 906, as depicted in FIGS. 1-3.

In one embodiment the structures described with reference to FIGS. 22-37 may be employed in a method of retrofitting the wiring of a base structure, e.g., concrete base 950, for an electrical vehicle charger to include a luminaire 75. The method can include mounting a base plate 920, 930 to an anchor base structure, e.g., concrete base 950. In one embodiment, the mounting structure further includes the base plate and assembly 900. In some embodiments, the anchor base structure 950 includes a main conduit 951 with power source wiring 903 extending therethrough. For example, the base plate 920, 930 may include an opening 924, 934 for a main conduit 951 passthrough and a secondary conduit 921, 931 that is integral with the base plate 920, 930, and is laterally spaced from the main conduit passthrough 924, 934. The mounting of the base plate 920, 930 to the base structure, e.g., concrete base 950, provides a spaced therebetween having dimensions for the passage of wiring. The method may further include mounting a main body 904 including an electrical box 905 therein to the base plate 920, 930. The power source wiring 930 can extend to the electrical box 950 and splits to include a branch 903b that extends back to the main conduit passthrough 924, 924 in the base plate 920, 930. The split in the wiring may be provided by a splitter 300A, as depicted in FIG. 4A and FIGS. 6A-6H, or the split in the wiring may be provide by a step down transformer 300B, as depicted in FIG. 4B and FIG. 7.

The method can further include extending the branch 302b that extends through the main conduit passthrough 924, 934 along a backside of the base plate 920, 930 to the secondary conduit 921, 931 that is integral with the base plate 920, 930. In a following step, a cable management structure 906 is mounted to the main body 904, wherein a passageway extends through the cable management structure 906 to a luminaire 75. The method can further include connecting the branch 903b from the power source wiring 903 that split at the electrical box 905 and extended back through the main conduit passthrough 924, 934 to the luminaire 75.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Spatially relative terms, such as “forward”, “back”, “left”, “right”, “clockwise”, “counter clockwise”, “beneath,” “below,” “lower,” “above,” “upper,” and the like, can be used herein for ease of description to describe one element's or feature's relationship to another element(s) or feature(s) as illustrated in the FIGs. It will be understood that the spatially relative terms are intended to encompass different orientations of the device in use or operation in addition to the orientation depicted in the FIGs. The terms “positioned on” means that a first element, such as a first structure, is present on a second element, such as a second structure, wherein intervening elements, such as an interface structure, e.g., interface layer, may be present between the first element and the second element. The term “direct contact” means that a first element, such as a first structure, and a second element, such as a second structure, are connected without any intermediary conducting, insulating or semiconductor layers at the interface of the two elements.

Having described preferred embodiments of a Luminaire Integrated into an Electrical Vehicle Charger, it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. An electric vehicle supply equipment comprising:
at least one structure having a form factor fitting a charging station including a first interface for charging electric vehicles and a second interface for powering a luminaire, wherein the first interface including a voltage for supporting level 2 charging, and the second interface is for powering the luminaire;
an electrical box mounted to the structure that includes a connection to grid power, the electrical box includes an AC circuit, wherein a splitter provides for electrical communication from the AC circuit to the first and second interface, wherein the splitter provides for splitting the neutral and line cables of the AC input into two branches, wherein a first branch of neutral and line cables provide electrical communication to the first interface having the voltage for supporting level 2 charging, and a second branch of neutral and line cables provide electrical communication to the second interface for powering the luminaire; and
an electric vehicle charger plug assembly in electrical communication with the first interface, wherein the luminaire is mounted to the housing and is in electrical communication with the second interface.

2. The electric vehicle supply equipment of claim 1, wherein an input voltage to the electric vehicle supply equipment (EVSE) is 240 VAC, and the first interface to the electric vehicle charger plug provides 240 VAC, and the second interface to the luminaire provides 100 VAC-277 VAC.

3. The electric vehicle supply equipment of claim 1, wherein the second interface to the luminaire provides a single phase power configuration selected from the group consisting 120 VAC, 240 VAC, 277 VAC, 480 VAC, and combinations thereof.

4. The electric vehicle supply equipment of claim 1, wherein the second interface to the luminaire provides a three phase power configuration selected from the group consisting of 120 VAC, 208 VAC, 240 VAC, 277 VAC, 480 VAC.

5. The electric vehicle supply equipment of claim 1, wherein the form factor for the structure includes a charger stand pillar including a first mount for the first interface at a first height, and a second mount for the second interface at a second height, the second height being greater than the first height.

6. The electric vehicle supply equipment device of claim 1, wherein the form factor of the structure includes a charging station housing including a display for charging data and a mount for reversibly engaging the electric vehicle charger plug assembly.

7. The electric vehicle supply equipment device of claim 1, wherein the luminaire is an overhead luminaire.

8. The electric vehicle supply equipment of claim 1, wherein the luminaire is a bollard luminaire.

9. An electric vehicle supply equipment comprising:
at least one structure having a form factor fitting a charging station including one interface for charging electric vehicles and at a second interface for powering overhead street lighting, wherein the first interface includes 240V outlet and the second interface includes a 100 VAC-277 VAC outlet;
an electrical box mounted to the structure that includes a connection to grid power, the electrical box including a 240V AC circuit, wherein a splitter provides for electrical communication from the 240V AC circuit to the first and second interface, the splitter provides for splitting the neutral and line cables of the AC input into two branches, wherein a first branch of neutral and line cables provide electrical communication to the first interface that includes the 240V outlet and a second branch of the neutral and line cables provide electrical communication to the second interface that includes the 100 VAC-277 VAC outlet; and
an electric vehicle charger plug assembly in electrical communication with the first interface, wherein an overhead luminaire is mounted to the housing and including electrical communication with the second interface that includes the 100 VAC-277 VAC outlet for powering the luminaire.

10. The electric vehicle supply equipment of claim 9, wherein the form factor for the structure includes a charger stand pillar including a first mount for the first interface at a first height, and a second mount for the second interface at a second height, the second height being greater than the first height.

11. The electric vehicle supply equipment of claim 9, wherein the form factor of the structure includes a charging station housing including a display for charging data and a mount for reversibly engaging the electric vehicle charger plug assembly.

12. The electric vehicle supply equipment of claim 11, wherein the form factor for the structure further include a luminaire support pillar, wherein the charging station housing is mounted to the luminaire support pillar.

13. The electric vehicle supply equipment of claim 9, wherein the overhead luminaire includes a light emitting diode (LED) light engine, and the overhead luminaire is mounted to an end of the luminaire support pillar that is opposite the end of the luminaire support pillar having the second connector at the base.

14. An electric vehicle supply equipment comprising:
at least one structure having a form factor for the electrical vehicle charger including one interface for charging electric vehicles, and at least a second interface for powering bollard lighting, wherein the first interface includes a 240V outlet, and the second interface includes a 100 VAC-277 VAC outlet;
an electrical box that includes a connection to grid power, which includes a 240V AC circuit, the electrical box includes a splitter that provides for electrical communication from the 240V AC circuit to the first and second interface, the splitter includes splitting the neutral and line cables of the AC input into two branches, wherein a first branch of neutral and line cables provide electrical communication to the first interface that includes the 240V outlet and a second branch of the neutral and line cables provide electrical communication to the second interface that includes the 100 VAC-277 VAC outlet; and
an electric vehicle charger plug assembly in electrical communication with the first interface that includes the 240V outlet, wherein the bollard luminaire is connected to the second interface including the 100 VAC-277 VAC outlet.

15. The electric vehicle supply equipment of claim 14, wherein a connection of the bollard luminaire may be on the sidewall of the form factor for the charging station.

16. A method of providing lighting for a charging station comprising:
providing a structure having a form factor fitting a charging station including a first interface for charging electric vehicles and a second interface for powering a luminaire, wherein the first interface including a voltage for supporting level 2 charging, and the second interface is for powering the luminaire;
connecting an electrical box for the charging station to grid power that includes an AC circuit, wherein a splitter provides for electrical communication from the AC circuit to the first and second interface, wherein the splitter provides for splitting the neutral and line cables of the AC input into two branches, wherein a first branch of neutral and line cables provide electrical communication to the first interface having the voltage for supporting level 2 charging, and a second branch of neutral and line cables provide electrical communication to the second interface for powering the luminaire;
installing a plug for engaging the charging point of an electric vehicle to the first interface; and
mounting the luminaire to the structure having the form factor fitting the charging station having electrical communication with the second interface.

17. The method of claim 16, wherein the AC circuit is 240 VAC, and the first interface to the electric vehicle charger plug provides 240 VAC, and the second interface to the luminaire provides 100 VAC-277 VAC.

18. The method of claim 16, wherein the second interface to the luminaire provides a single phase power configuration selected from the group consisting 120 VAC, 240 VAC, 277 VAC, 480 VAC, and combinations thereof, or the second interface to the luminaire provides a three phase power configuration selected from the group consisting of 120 VAC, 208 VAC, 240 VAC, 277 VAC, 480 VAC, and combinations thereof.

19. The method of claim 16, wherein the luminaire is an overhead luminaire or a bollard luminaire.

20. A method of retrofitting the wiring of a base structure for an electrical vehicle charger to include a luminaire comprising:
mounting a base plate to an anchor base structure, the anchor base structure including main conduit with power source wiring extending therethrough, the base plate including an opening for a main conduit passthrough and a secondary conduit integral with the base plate laterally spaced from the main conduit passthrough, wherein the mounting of the base plate to the base structure provides a spaced therebetween having dimensions for the passage of wiring;
mounting a main body including an electrical box therein to the base plate, wherein the power source wiring extends to the electrical box and splits to include a branch that extends back to the main conduit passthrough in the base plate;
extending the branch that extended through the main conduit passthrough along a backside of the base plate to the secondary conduit that is integral with the base plate;
mounting a cable management structure, wherein a passageway extends through the cable management structure to a luminaire; and
connecting the branch from the power source wiring that split at the electrical box and extended back through the main conduit passthrough to the luminaire.
